(19) United States
(12) Patent Application Publication
(10) Pub. No.: US 2019/0050366 A1
(43) Pub. Date: Feb. 14, 2019

(54) DEVICE, EVENT AND MESSAGE PARAMETER ASSOCIATION IN A MULTI-DROP BUS

(71) Applicant: QUALCOMM Incorporated, San Diego, CA (US)

(72) Inventors: Lalan Jee MISHRA, San Diego, CA (US); Raghukul TILAK, San Diego, CA (US); Zhurang ZHAO, San Diego, CA (US); Elisha ULMER, Kfar Baruch (IL); Richard Dominic WIETFELDT, San Diego, CA (US); Matthew SEVERSON, Austin, TX (US)

(21) Appl. No.: 16/058,599

(22) Filed: Aug. 8, 2018

Related U.S. Application Data
(60) Provisional application No. 62/545,422, filed on Aug. 14, 2017.

(51) Int. Cl. G06F 13/42; G06F 9/448; G06F 9/30

(52) U.S. Cl. CPC G06F 13/4282; G06F 9/30101; G06F 9/4498; G06F 13/4221

(57) ABSTRACT

Systems, methods, and apparatus for communication virtualized general-purpose input/output (GPIO) signals over a serial communication link. A method performed at a device coupled to a serial bus includes determining that GPIO state information corresponding to a physical GPIO pin or signal is available in an event register that has a first bit width and includes information identifying one or more devices associated with the event register, and exchanging the GPIO state information with the one or more devices over the serial bus. The GPIO state information may be transmitted over the serial bus in accordance with configuration information stored in the event register. The configuration information may include an address identifying the one or more devices. The configuration information may include addressing information identifying a target register in the one or more devices. The configuration information may include information identifying a mode of communication for transmitting the GPIO state information.

### PRIORITY CLAIM

This application claims priority to and the benefit of U.S. Provisional Patent Application Ser. No. 62/545,422 filed in the U.S. Patent Office on Aug. 14, 2017, the entire content of this application being incorporated herein by reference as if fully set forth below in its entirety and for all applicable purposes.

### TECHNICAL FIELD

The present disclosure relates generally to serial communication and input/output pin configuration and, more particularly, to optimizing a register set configured for serial messaging and virtual general-purpose input/output state.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a serial bur or a parallel bus. General-purpose serial interfaces known in the industry, including the Inter-Integrated Circuit (I2C or I²C) serial bus and its derivatives and alternatives, including interfaces defined by the Mobile Industry Processor Interface (MIPI) Alliance, such as the I3C interface, the system power management interface (SPMI), and the Radio Frequency Front-End (RFFE) interface.

In one example, the I2C serial bus is a serial single-ended computer bus that was intended for use in connecting low-speed peripherals to a processor. Some interfaces provide multi-master buses in which two or more devices can serve as a bus master for different messages transmitted on the serial bus. In another example, the RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single integrated circuit (IC) device, or provided in multiple IC devices. In a mobile communications device, multiple antennas and radio transceivers may support multiple concurrent RF links.

In many instances, a number of command and control signals are employed to connect different component devices in mobile communication devices. These connections consume precious general-purpose input/output (GPIO) pins within the mobile communication devices and it would be desirable to replace the physical interconnects with signals carried in information transmitted over existing serial data links.

As mobile communication devices continue to include a greater level of functionality, improved serial communication techniques are needed to support low-latency transmissions between peripherals and application processors.

### SUMMARY

Certain aspects of the disclosure relate to systems, apparatus, methods and techniques that can provide optimized low-latency communications between different devices such that GPIO signals may be carried as virtual signals. A virtual GPIO finite state machine (VGI FSM) operates on a register configuration that maintains GPIO state information from multiple sources and bus structures, and that enables the state information to be translated to device-specific register formats for transmission to one or more devices over a data communication bus.

In various aspects of the disclosure, a method performed at a device coupled to a serial bus includes determining that GPIO state information corresponding to a physical GPIO pin or signal is available in an event register that has a first bit width and includes information identifying one or more devices associated with the event register, and exchanging the GPIO state information with the one or more devices over the serial bus. The GPIO state information may be transmitted over the serial bus in accordance with configuration information stored in the event register. The configuration information may include an address identifying the one or more devices. The configuration information may include addressing information identifying a target register in the one or more devices. The configuration information may include information identifying a mode of communication for transmitting the GPIO state information.

In certain aspects, the GPIO state information may be stored in a first device register, and the contents of the first device register may be transmitted over the serial bus. An address identifying the one or more devices may be stored in a second device register, and the content of the second device register may be transmitted with the first device register over the serial bus. An address identifying the target register may be stored in a third device register, and the content of the third device register may be transmitted with the first device register over the serial bus. The first device register may have a second bit width that is different from the first bit width.

In some aspects, the mode of communication defines whether certain transmissions over the serial bus are to be encrypted. In one example, the mode of communication defines whether the GPIO state information is encrypted when transmitted. In another example, the mode of communication defines whether messages transmitted over the serial bus are to be encrypted. The mode of communication may define whether the GPIO state information is retransmitted after an error is detected in a first transmission. The mode of communication may define whether the GPIO state information is transmitted in multiple transmission. The mode of communication may define a format of the addressing information identifying the target register in the one or more devices. The mode of communication may identify a priority of the GPIO state information.

In one aspect, exchanging the GPIO state information includes transmitting or receiving a data packet in accordance with an SPMI protocol. Exchanging the GPIO state information may include transmitting or receiving a data packet in accordance with an RFFE, protocol.

In various aspects of the disclosure, an apparatus has a set of event registers, each event register storing GPIO state information corresponding to a physical GPIO pin or signal and configuration information corresponding to the GPIO state information, a bus interface configured to communicate virtual GPIO information over a serial bus, and a finite state machine coupled to the set of event registers and the bus interface. The finite state machine may be configured to determine that GPIO state information corresponding to a physical GPIO pin or signal has changed in a first event register, and exchange the GPIO state information with the one or more devices over the serial bus. The configuration information may include an address identifying the one or more devices, addressing information identifying a target register in the one or more devices and information identifying a mode of communication for transmitting the GPIO state information. The first event register may have a first bit width and may include information identifying one or more devices associated with the event register. The GPIO state information is transmitted over the serial bus in accordance with the configuration information stored in the first event register.

In various aspects of the disclosure, an apparatus includes means for determining that GPIO state information corresponding to a physical GPIO pin or signal is available in an event register, and means for exchanging the GPIO state information with the one or more devices over a serial bus. The GPIO state information may be transmitted over the serial bus in accordance with configuration information stored in the event register. The event register may have a first bit width and may include information identifying one or more devices associated with the event register. The configuration information may include an address identifying the one or more devices, addressing information identifying a target register in the one or more devices and information identifying a mode of communication for transmitting the GPIO state information.

In various aspects of the disclosure, a processor-readable storage medium stores instructions that, when executed by at least one processor or state machine of a processing circuit, cause the processing circuit or state machine to determine that GPIO state information corresponding to a physical GPIO pin or signal is available in an event register, and exchange the GPIO state information with the one or more devices over a serial bus. The event register may have a first bit width and may include information identifying one or more devices associated with the event register. The GPIO state information may be transmitted over the serial bus in accordance with configuration information stored in the event register. The configuration information may include an address identifying the one or more devices, addressing information identifying a target register in the one or more devices and information identifying a mode of communication for transmitting the GPIO state information.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device configuration for coupling various radio frequency front-end devices using multiple RFFE buses.

FIG. 4 illustrates a device that employs an SPMI bus to couple various front-end devices in accordance with certain aspects disclosed herein.

FIG. 5 illustrates an apparatus that includes an Application Processor and multiple peripheral devices that may be adapted according to certain aspects disclosed herein.

FIG. 6 illustrates a device that employs a serial bus to couple various front-end devices in accordance with certain aspects disclosed herein.

FIG. 7 illustrates an apparatus that has been adapted to support Virtual GPIO in accordance with certain aspects disclosed herein.

FIG. 8 illustrates an example of a system which includes one or more communication links that employ sideband GPIO.

FIG. 9 illustrates an example of a system which virtualizes and consolidates communication of GPIO state associated with multiple devices and/or communication links using a single serial communication link in accordance with certain aspects disclosed herein.

FIG. 10 illustrates an example of an event register that may be used to implement a versatile virtual GPIO configuration in accordance with certain aspects disclosed herein.

FIG. 11 illustrates an example of system with a state machine operating autonomously using the event register of FIG. 10 in accordance with certain aspects disclosed herein.

FIG. 12 is a first flowchart illustrating processing of a 32-bit event register during an event transmission operation in accordance with certain aspects disclosed herein.

FIG. 13 is a second flowchart illustrating processing of a 32-bit event register during an event receive operation in accordance with certain aspects disclosed herein.

FIGS. 14-16 illustrate message buffers that include configuration information and message payloads in accordance with certain aspects disclosed herein.

FIG. 17 illustrates one example of an apparatus employing a processing circuit that may be adapted according to certain aspects disclosed herein.

FIG. 18 is a third flowchart illustrating certain operations of device adapted in accordance with certain aspects disclosed herein.

FIG. 19 illustrates an example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a shared communication interface that may include a serial bus or other data communication link to connect processors with modems and other peripherals. The serial bus or other data communication link may be operated in accordance with multiple standards or protocols defined. In various examples, a serial bus may be operated in accordance in with a I2C protocol, I3C protocol, SPMI protocol and/or RFFE protocol. According to certain aspects disclosed herein, GPIO pins and signals may be virtualized into GPIO state information that may be transmitted over a data communication link Virtualized GPIO state information that may be transmitted over a variety of communication links, including links that include wired and wireless communication links. For example, virtualized GPIO state information can be packetized or otherwise formatted for transmission over wireless networks including Bluetooth, WLAN, cellular networks, etc. Examples involving wired communication links are described herein to facilitate understanding of certain aspects. These aspects invariably apply to implementations in which transmission of GPIO state information includes transmission over wireless networks.

A number of different protocol schemes may be used for communicating messaging and data over communication links Existing protocols have well-defined and immutable structures in the sense that their structures cannot be changed. In some examples, a serial communication bus that is operated in accordance with I2C, I3C, SPMI, RFFE, or other standards or protocols may be used to tunnel different protocols with different register and data format requirements, different data transmission volumes and/or different transmission schedules.

Certain aspects disclosed herein provide methods, circuits and systems that are adapted to enable a device to provide a uniform register format for GPIO state information that supports multiple interfaces connecting the device and to one or more other devices. According to certain aspects disclosed herein, a register configuration may be defined that enables a state machine to manage virtual GPIO state information for a wide variety of physical GPIO configurations, bus architectures associated with the physical GPIO and protocols controlling the operation of a bus used to communicate virtual GPIO information. The register configuration can enable the state machine to operate autonomously. The state machine may be adapted to use the register configuration when target devices operate with different register widths. In one example, the state machine may be adapted to map 32-bit wide virtual GPIO registers to 8-bit registers and/or 16-bit registers in devices targeted to receive virtual GPIO information. Other mappings may be implemented according to preference or requirement of certain architectures. Bit definitions and bit position in the register may be altered based on architectural convenience. The register configuration enables an atomic approach to register definition, thereby ensuring maximum flexibility, and expandability.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

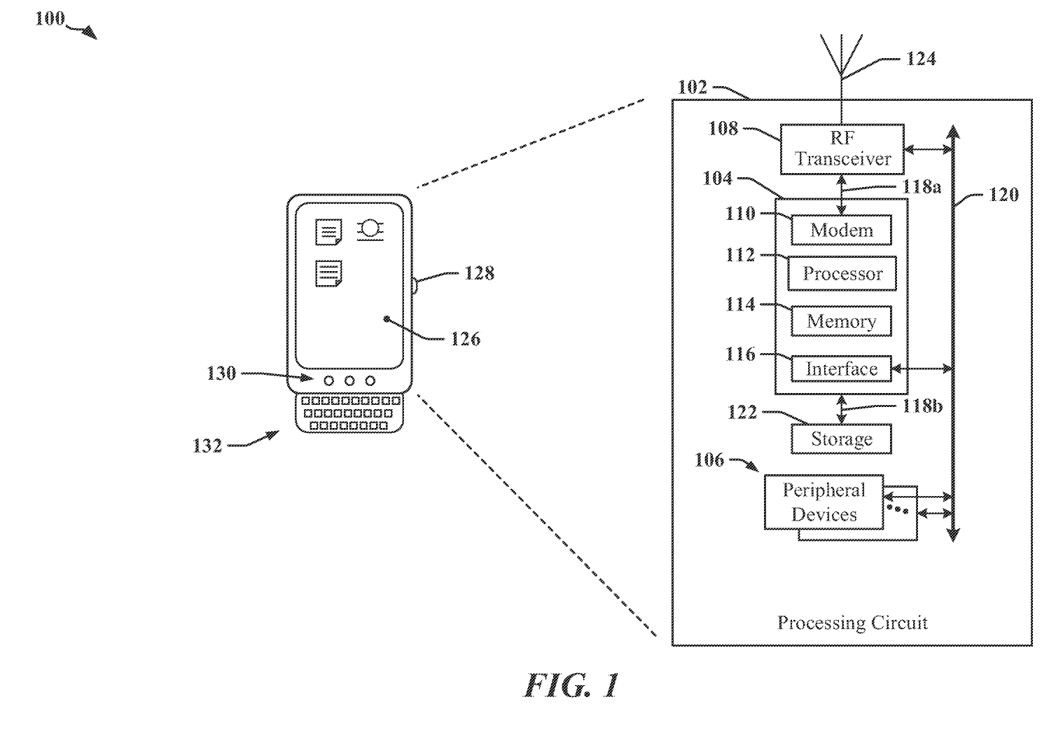

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

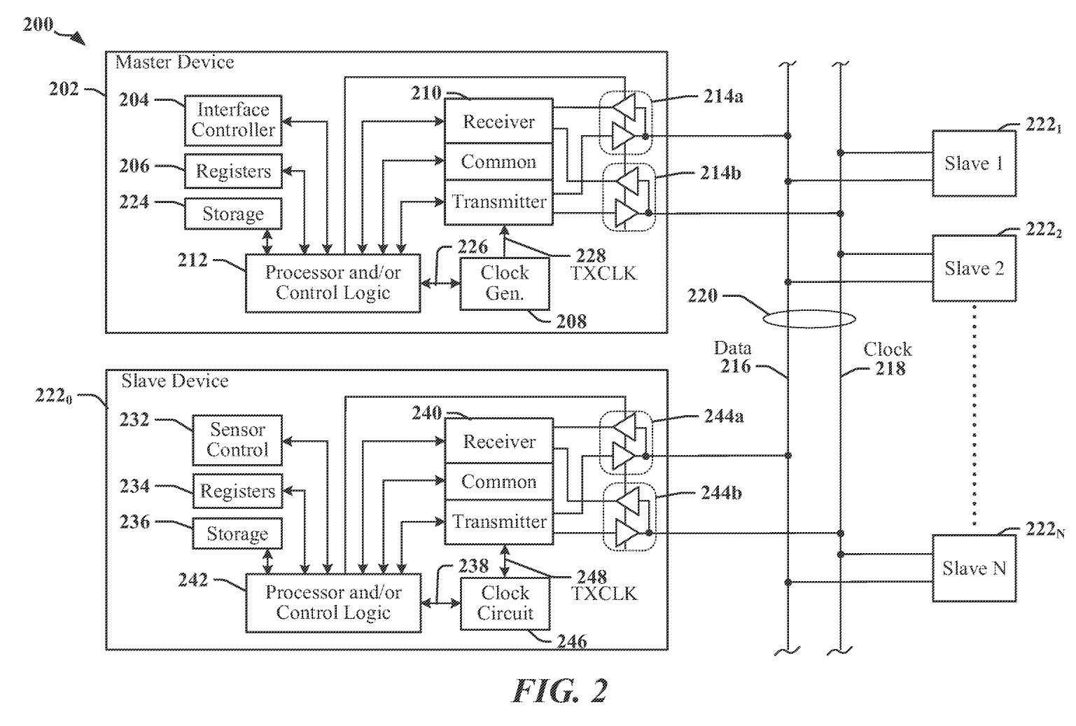

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as applications processors, SoCs or ASICs. In various implementations the devices 202 and 222₀-222_{N} may include, support or operate as a modem, a signal processing device, a display driver, a camera, a user interface, a sensor, a sensor controller, a media player, a transceiver, and/or other such components or devices. In some examples, one or more of the slave devices 222₀-222_{N} may be used to control, manage or monitor a sensor device. Communications between devices 202 and 222₀-222_{N} over the serial bus 220 is controlled by a bus master 202. Certain types of bus can support multiple bus masters 202.

In one example, a master device 202 may include an interface controller 204 that may manage access to the serial bus, configure dynamic addresses for slave devices 222₀-222_{N} and/or generate a clock signal 228 to be transmitted on a clock line 218 of the serial bus 220. The master device 202 may include configuration registers 206 or other storage 224, and other control logic 212 configured to handle protocols and/or higher level functions. The control logic 212 may include a processing circuit such as a state machine, sequencer, signal processor or general-purpose processor. The master device 202 includes a transceiver 210 and line drivers/receivers 214a and 214b. The transceiver 210 may include receiver, transmitter and common circuits, where the common circuits may include timing, logic and storage circuits and/or devices. In one example, the transmitter encodes and transmits data based on timing in the clock signal 228 provided by a clock generation circuit 208. Other timing clocks 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222₀ configured to operate as a slave device may provide a control function, module or circuit 232 that includes circuits and modules to support a display, an image sensor, and/or circuits and modules that control and communicate with one or more sensors that measure environmental conditions. The slave device 222₀ may include configuration registers 234 or other storage 236, control logic 242, a transceiver 240 and line drivers/receivers 244a and 244b. The control logic 242 may include a processing circuit such as a state machine, sequencer, signal processor or general-purpose processor. The transceiver 210 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. The clock signal 248 may be derived from a signal received from the clock line 218. Other timing clocks 238 may be used by the control logic 242 and other functions, circuits or modules.

The serial bus 220 may be operated in accordance with I2C, I3C, SPMI, RFFE, and/or other protocols. At least one device 202, 222₀-222_{N} may be configured to operate as a master device and a slave device on the serial bus 220. Two or more devices 202, 222₀-222_{N} may be configured to be operable as a master device on the serial bus 220.

In an example where the serial bus 220 is operated in accordance with an I3C protocol, devices that communicate using the I3C protocol can coexist on the same serial bus 220 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the serial bus 220, in addition to data formats and aspects of bus control. In some aspects, the I2C and I3C protocols may define direct current (DC) characteristics affecting certain signal levels associated with the serial bus 220, and/or alternating current (AC) characteristics affecting certain timing aspects of signals transmitted on the serial bus 220. In some examples, a 2-wire serial bus 220 transmits data on a data line 216 and a clock signal on the clock line 218. In some instances, data may be encoded in the signaling state, or transitions in signaling state of the data line 216 and the clock line 218.

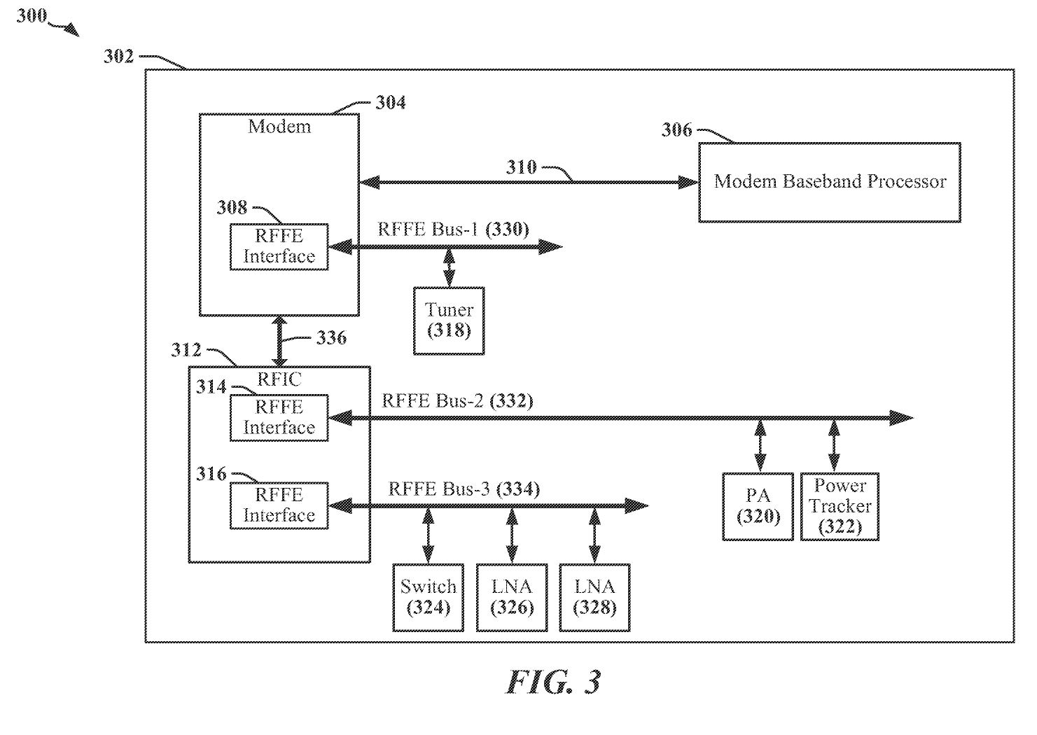

FIG. 3 is a block diagram 300 illustrating a second example of a configuration of communication links in a chipset or device 302 that employs multiple RFFE buses 330, 332, 334 to couple various RF front-end devices 318, 320, 322, 324, 326 328. In this example, a modem 304 includes an RFFE interface 308 that couples the modem 304 to a first RFFE bus 330. The modem 304 may communicate with a baseband processor 306 and a Radio-Frequency IC (RFIC 312) through one or more communication links 310, 336. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like.

In various examples, the device 302 may be implemented with a baseband processor 306, modem 304, RFIC 312, multiple communications links 310, 336, multiple RFFE buses 330, 332, 334 and/or other types of buses. The device 302 may include other processors, circuits, modules and may be configured for various operations and/or different functionalities. In the example illustrated in FIG. 3, the modem 304 is coupled to an RF tuner 318 through its RFFE interface 308 and the first RFFE bus 330. The RFIC 312 may include one or more RFFE interfaces 314, 316, controllers, state machines and/or processors that configure and control certain aspects of the RF front-end. The RFIC 312 may communicate with a PA 320 and a power tracking module 322 through a first RFFE interface 314 and the second RFFE bus 332. The RFIC 312 may communicate with a switch 324 and one or more LNAs 326, 328 through a second RFFE interface 316 and the third RFFE bus 334.

Bus latency can affect the ability of a serial bus to handle high-priority, real-time and/or other time-constrained messages. Low-latency messages, or messages requiring low bus latency, may relate to sensor status, device-generated real-time events and virtualized general-purpose input/output (GPIO). In one example, bus latency may be measured as the time elapsed between a message becoming available for transmission and the delivery of the message or, in some instances, commencement of transmission of the message. Other measures of bus latency may be employed. Bus latency typically includes delays incurred while higher priority messages are transmitted, interrupt processing, the time required to terminate a datagram in process on the serial bus, the time to transmit commands causing bus turnaround between transmit mode and receive mode, bus arbitration and/or command transmissions specified by protocol.

In certain examples, latency-sensitive messages may include coexistence messages. Coexistence messages are transmitted in a multisystem platform to prevent or reduce instances of certain device types impinging on each other, including for example, switches 324, LNAs 326, 328, PAs 320 and other types of device that operate concurrently in a manner that can generate inter-device interference, or that could potentially cause damage to one or more devices. Devices that may interfere with one another may exchange coexistence management (CxM) messages to permit each device to signal imminent actions that may result in interference or conflict. CxM messages may be used to manage operation of shared components including a switch 324, LNA 326, 328, PA 320 and/or an antenna.

Multi-drop interfaces such as I3C, SPMI, RFFE, etc. can reduce the number of physical input/output (I/O) pins used to communicate between multiple devices. Protocols that support communication over a multi-drop serial bus define a datagram structure used to transmit command, control and data payloads. Datagram structures for different protocols define certain common features, including addressing used to select devices to receive or transmit data, clock generation and management, interrupt processing and device priorities. In this disclosure, the example of SPMI and RFFE protocols may be employed to illustrate certain aspects disclosed herein. However, the concepts disclosed herein are applicable to other serial bus protocols and standards. Some similarities exist between SPMI and RFFE datagram structures.

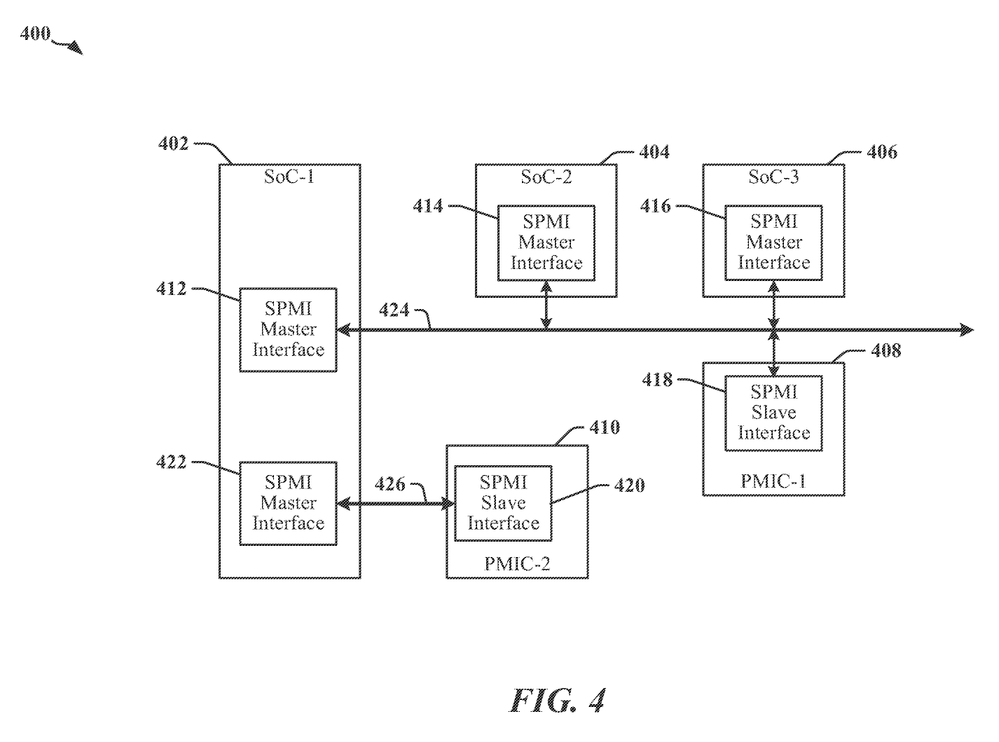

FIG. 4 illustrates an example of a system 400 that employs one or more serial buses 424, 426 operated in accordance with SPMI protocols. SPMI protocols may be used to implement a general-purpose communication link. In various examples, SPMI protocols may be used to provide a power management control bus that can communicate commands to cause circuits and/or functional components to reset, sleep, shutdown, wakeup, and so on. A two-wire serial bus 424, 426 may be used to connect one or more master devices 402, 404, 406 to multiple slave devices 408, 410. In one implementation, between one and four master devices may be coupled to the serial bus and up to 16 slave devices may be supported. The serial bus 424, 426 includes a first wire (SCLK) that carries a clock signal and a second wire that carries a data signal (SDATA). SPMI protocols support bus contention arbitration, request arbitration and group addressing (to permit multiple slaves 408, 410 to written concurrently or simultaneously by a master device 402, 404, 406. In some implementations, SPMI supports a low speed mode that operates with a clock frequency of between 32 kHz and 15 MHz, and a high-speed mode that operates with a clock frequency of between 32 kHz and 26 MHz. SPMI devices may be required to acknowledge certain commands.

In the illustrated example, the system 400 includes three SoCs 402, 404, 406 and two power management integrated circuits (PMICs 408, 410). Other types of peripheral devices may be coupled to a serial bus 424, 426 operated in accordance with SPMI protocols. In the illustrated system 400, a first serial bus 424 couples a bus master 412, 414, 416 on each SoC 402, 404, 406 and a bus slave 418 on a first PMIC 408, with a second serial bus 426 couples a bus slave 420 in a second PMIC 410 to an additional bus master 422 provided in one SoC 402.

### Virtual General-Purpose Input/Output

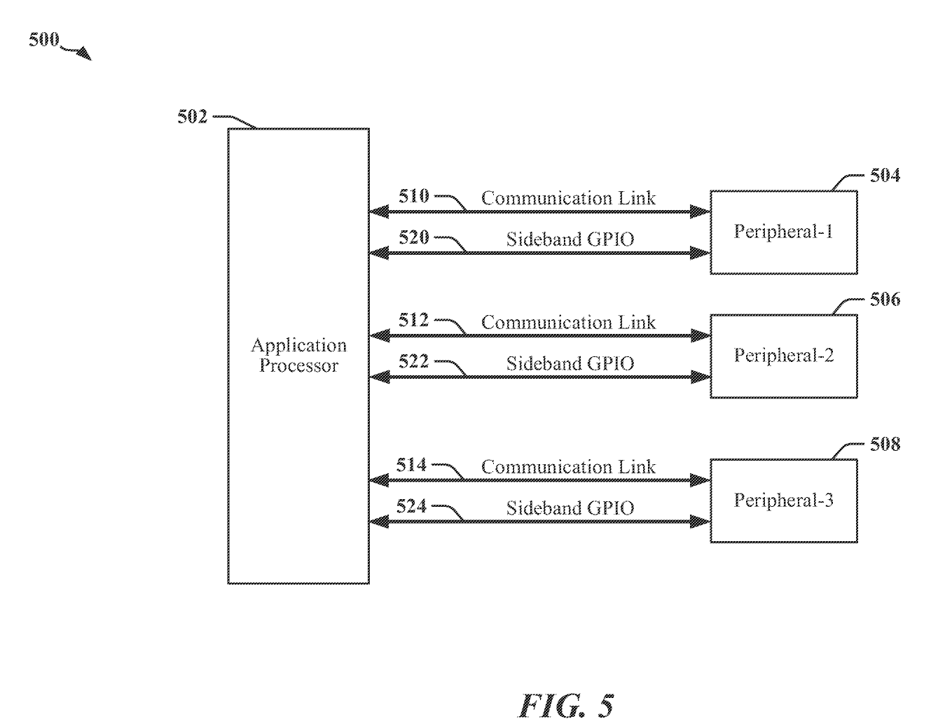

Mobile communication devices, and other devices that are related or connected to mobile communication devices, increasingly provide greater capabilities, performance and functionalities. In many instances, a mobile communication device incorporates multiple IC devices that are connected using a variety of communications links FIG. 5 illustrates an apparatus 500 that includes an Application Processor 502 and multiple peripheral devices 504, 506, 508. In the example, each peripheral device 504, 506, 508 communicates with the Application Processor 502 over a respective communication link 510, 512, 514, which may be operated in accordance with mutually different protocols. Communication between the Application Processor 502 and each peripheral device 504, 506, 508 may involve additional wires that carry control or command signals between the Application Processor 502 and the peripheral devices 504, 506, 508. These additional wires may be referred to as sideband general purpose input/output (sideband GPIO 520, 522, 524), and in some instances the number of connections needed for sideband GPIO 520, 522, 524 can exceed the number of connections used for a communication link 510, 512, 514.

GPIO provides generic pins/connections that may be customized for particular applications. For example, a GPIO pin may be programmable to function as an output, input pin or a bidirectional pin, in accordance with application needs. In one example, the Application Processor 502 may assign and/or configure a number of GPIO pins to conduct handshake signaling or inter-processor communication (IPC) with a peripheral device 504, 506, 508 such as a modem. When handshake signaling is used, sideband signaling may be symmetric, where signaling is transmitted and received by the Application Processor 502 and a peripheral device 504, 506, 508. With increased device complexity, the increased number of GPIO pins used for IPC communication may significantly increase manufacturing cost and limit GPIO availability for other system-level peripheral interfaces.

According to certain aspects of this disclosure, the state of GPIO, including GPIO associated with a communication link, may be captured, serialized and transmitted over a data communication link. In one example, captured GPIO may be transmitted in packets over a serial bus operated in accordance with an I2C, I3C, SPMI, RFFE and/or another protocol. In the example of a serial bus operated in accordance with I3C protocols, common command codes may be used to indicate packet payload and/or destination.

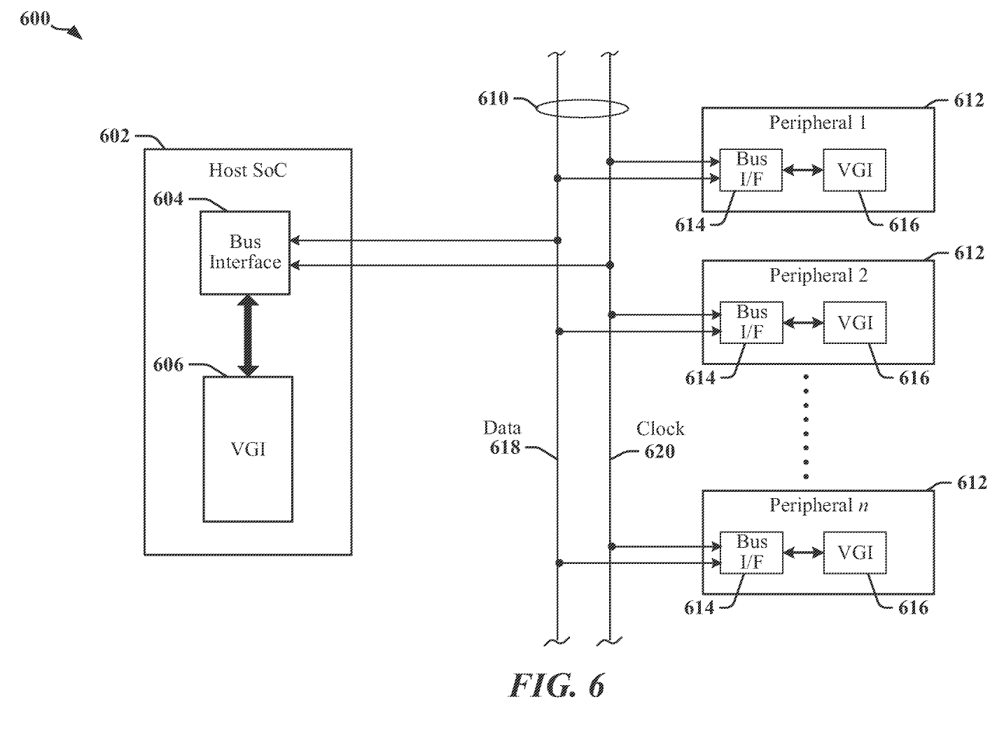

FIG. 6 illustrates an example of an apparatus 600 that uses a serial bus 610 to couple various devices including a host SoC 602 and a number of peripheral devices 612. The host SoC 602 may include a virtual GPIO finite state machine (VGI FSM 606) and a bus interface 604, where the bus interface 604 cooperates with corresponding bus interfaces 614 in the peripheral devices 612 to provide a communication link between the host SoC 602 and the peripheral devices 612. Each peripheral device 612 includes a VGI FSM 616. In one example, communications between the SoC 602 and a peripheral device 612 may be serialized and transmitted over a multi-wire serial bus 610 in accordance with an I3C protocol. The host SoC 602 may include one or more bus interfaces, including I2C, I3C, SPMI and/or RFFE bus interfaces. In some examples, the host SoC 602 may include a configurable interface that may be employed to communicate using I2C, I3C, SPMI, RFFE and/or another suitable protocol. In some examples, a multi-wire serial bus 610 may transmit data in a data signal over a data wire 618 and timing information in a clock signal over a clock wire 620.

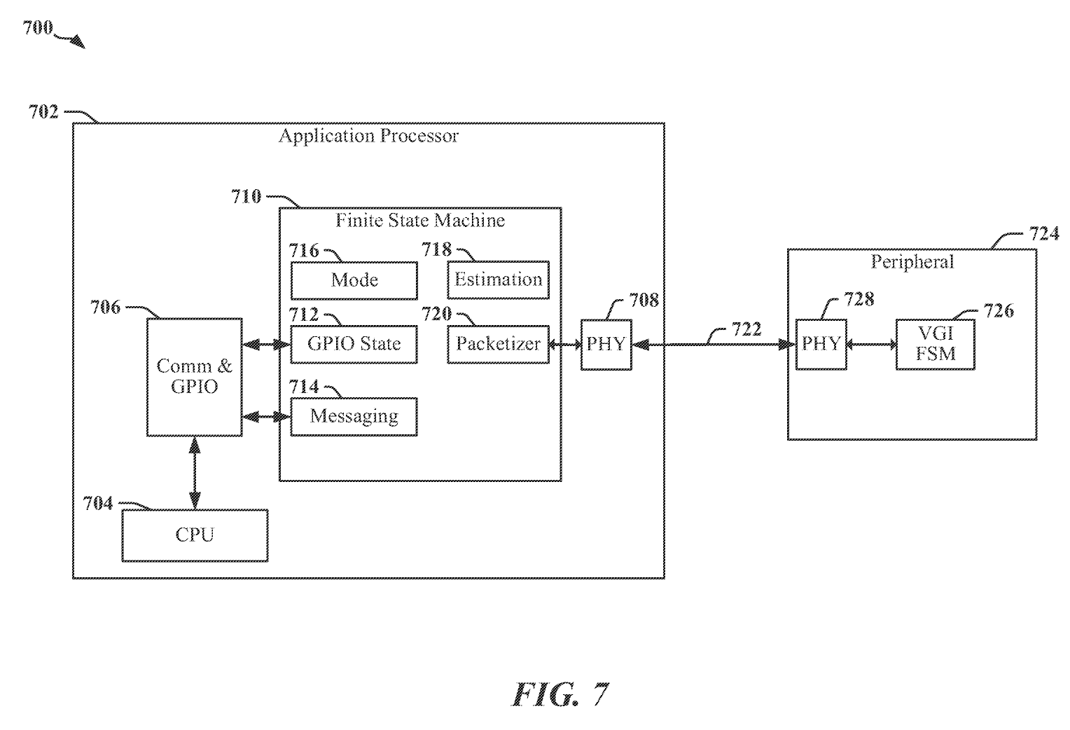

FIG. 7 illustrates an apparatus 700 that is adapted to support Virtual GPIO (VGI or VGMI) in accordance with certain aspects disclosed herein. VGI circuits and techniques can reduce the number of physical pins and connections used to connect an Application Processor 702 with a peripheral device 724. VGI enables a plurality of GPIO signals to be serialized into virtual GPIO state that can be transmitted over a communication link 722. In one example, virtual GPIO state may be encoded in packets that are transmitted over a communication link 722 that includes a multi-wire bus, including a serial bus. When the communication link 722 is provided as serial bus, the receiving peripheral device 724 may deserialize received packets and may extract messages and virtual GPIO state. A VGI FSM 726 in the peripheral device 724 may convert received virtual GPIO state to physical GPIO signals that can be presented at an internal GPIO interface.

In another example, the communication link 722 may be a provided by a radio frequency transceiver that supports RF communication using, for example, a Bluetooth protocol, a WLAN protocol, a cellular wide area network, and/or another RF communication protocol. When the communication link 722 includes an RF connection, messages and virtual GPIO signals may be encoded in packets, frames, subframes, or other structures that can be transmitted over the communication link 722, and the receiving peripheral device 724 may extract, deserialize and otherwise process received signaling to obtain the messages and virtual GPIO state. Upon receipt of messages and/or virtual GPIO state, the VGI FSM 726 or another component of the receiving device may interrupt its host processor to indicate receipt of messages and/or any changes in physical GPIO signals.

In an example in which the communication link 722 is provided as a serial bus, messages and/or virtual GPIO state may be transmitted in packets configured for an I2C, I3C, SPMI, RFFE or another standardized serial interface. In the illustrated example, VGI techniques are employed to accommodate I/O bridging between an Application Processor 702 and a peripheral device 724. The Application Processor 702 may be implemented as an ASIC, SoC or some combination of devices. The Application Processor 702 includes a processor (central processing unit or CPU 704) that generates messages and GPIO associated with one or more communications channels 706. GPIO signals, events and/or other messages produced by the communications channels 706 may be monitored by respective monitoring circuits 712, 714 in a VGI FSM 726. In some examples, a GPIO monitoring circuit 712 may be adapted to produce virtual GPIO state representative of the state of physical GPIO signals and/or changes in the state of the physical GPIO signals. In some examples, other circuits are provided to produce the virtual GPIO state representative of the state of physical GPIO signals and/or changes in the state of the physical GPIO signals.

An estimation circuit 718 may be configured to estimate latency information for the GPIO signals and messages, and may select a protocol, and/or a mode of communication for the communication link 722 that optimizes the latency for encoding and transmitting the GPIO signals and messages. The estimation circuit 718 may maintain protocol and mode information 716 that characterizes certain aspects of the communication link 722 to be considered when selecting the protocol, and/or a mode of communication. The estimation circuit 718 may be further configured to select a packet type for encoding and transmitting the GPIO signals and messages as virtual GPIO state. The estimation circuit 718 may provide configuration information used by a packetizer 720 to encode the GPIO signals and messages as virtual GPIO state. In one example, the configuration information is provided as a command that may be encapsulated in a packet such that the type of packet and/or a type of payload data (e.g., VGI state) can be determined at a receiver. The configuration information may also be provided to physical layer circuits (PHY 708). The PHY 708 may use the configuration information to select a protocol and/or mode of communication for transmitting the associated packet. The PHY 708 may then generate the appropriate signaling to transmit the packet.

The peripheral device 724 may include a VGI FSM 726 that may be configured to process data packets received from the communication link 722. The VGI FSM 726 at the peripheral device 724 may extract messages and may map bit positions in virtual GPIO state onto physical GPIO pins in the peripheral device 724. In certain embodiments, the communication link 722 is bidirectional, and both the Application Processor 702 and a peripheral device 724 may operate as both transmitter and receiver.

The PHY 708 in the Application Processor 702 and a corresponding PHY 728 in the peripheral device 724 may be configured to establish and operate the communication link 722. The PHY 708 and 728 may be coupled to, or include an RF transceiver 108 (see FIG. 1) that supports RF communications. In some examples, the PHY 708 and 728 may support a two-wire interface such an interface based on I2C, I3C, RFFE, SPMI or another type of interface in the Application Processor 702 and in the peripheral device 724. Virtual GPIO state and messages may be encapsulated into a packet transmitted over the communication link 722, which may be a multi-wire serial bus or multi-wire parallel bus for example.

VGI tunneling, as disclosed herein, can be implemented using existing or available protocols configured for operating the communication link 722, and without the full complement of physical GPIO pins. VGI FSMs 710, 726 may handle GPIO signaling without intervention of a processor in the Application Processor 702 and/or in the peripheral device 724. The use of VGI can reduce pin count, power consumption, and latency associated with the communication link 722.

At the receiving device virtual GPIO state can be converted into physical GPIO signals. Certain characteristics of the physical GPIO pins may be configured using the virtual GPIO state or messages. For example, slew rate, polarity, drive strength, and other related parameters and attributes of the physical GPIO pins may be configured using the virtual GPIO state or messages. Configuration parameters used to configure the physical GPIO pins may be stored in configuration registers associated with corresponding GPIO pins. These configuration parameters can be addressed using a proprietary or conventional protocol such as I2C, I3C, SPMI or RFFE. In one example, configuration parameters may be maintained in addressable registers. Certain aspects disclosed herein relate to reducing latencies associated with the transmission of configuration parameters and corresponding addresses (e.g., addresses of registers used to store configuration parameters).

The VGI interface enables transmission of virtual GPIO state and other messages, whereby virtual GPIO state, messages, or both can be sent in the serial data stream over a communication link 722. In one example, a serial data stream may be transmitted in packets and/or as a sequence of transactions over a serial bus operated in accordance with an I2C, I3C, SPMI or RFFE protocol. The presence of virtual GPIO data in frame transmitted over the serial bus may be signaled using a special command code to identify the frame as a VGI frame. VGI frames may be transmitted as broadcast frames or addressed frames. In some implementations, a serial data stream may be transmitted in a form that resembles a universal asynchronous receiver/transmitter (UART) signaling protocol, in what may be referred to as VGI_UART mode of operation.

### Consolidating GPIO for Multiple Devices or Communication Links

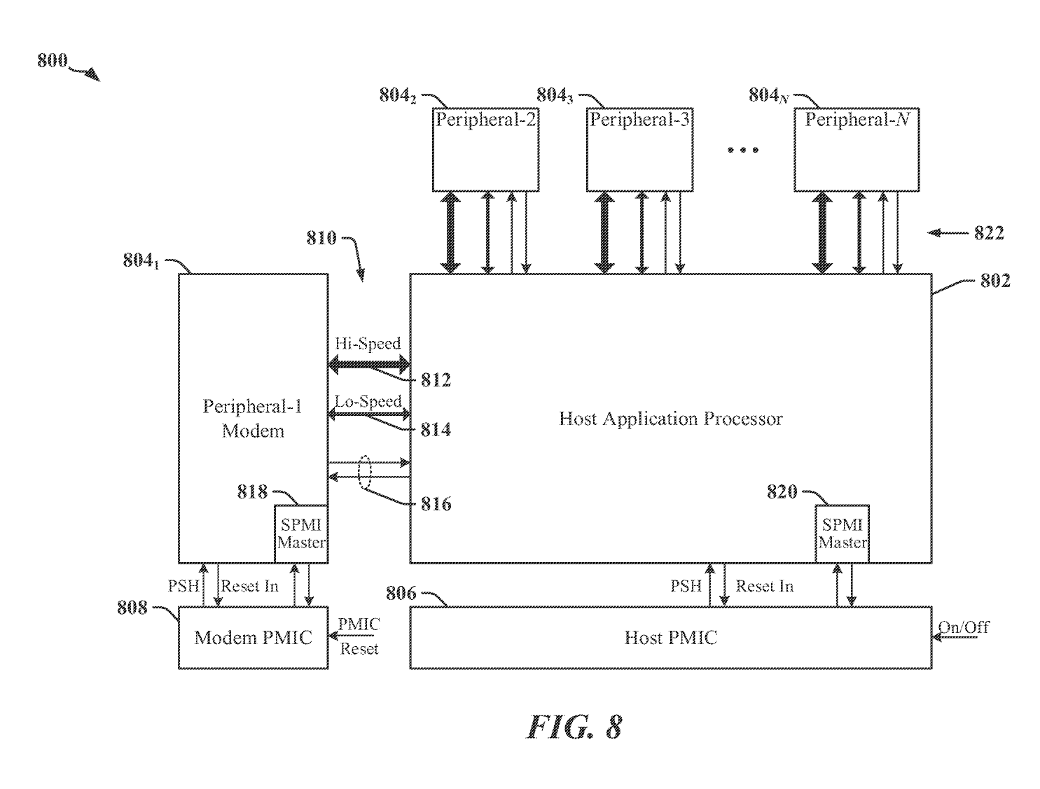

FIG. 8 illustrates an example of a system 800 that includes one or more communication links that employ sideband GPIO and that may not easily be serialized and transmitted in a single serial link In some examples, there may be an impediment to transmitting sideband GPIO over a single parallel data communication link. To facilitate description, the example of a serial data link may be employed, although the concepts described herein may be applied to parallel data communication links. The system 800 may include an application processor 802 that can serve as a host device on various communication links, multiple peripherals 804₁-804_{N}, and one or more power management integrated circuits (PMICs 806, 808). In the illustrated system 800, at least a first peripheral 804₁ may include a modem. The application processor 802 and the first peripheral 804₁ may be coupled to respective PMICs 806, 808 using GPIO that provides a combination of reset and other signals, and one or more bus interfaces (SPMI 818, 820). The SPMI 818, 820 operates as a serial interface defined by the MIPI Alliance that is optimized for the real-time control of devices including PMICs 806, 808. The SPMI 818, 820 may be configured as a shared bus that provides high-speed, low-latency connection for devices, where data transmissions may be managed according to priorities assigned to different traffic classes.

The application processor 802 may be coupled to each of the peripherals 804₁-804_{N} using multiple communication links 812, 814 and GPIO 816. For example, the application processor 802 may be coupled to the first peripheral 804₁ using a high-speed bus 812, a low-speed bus 814 and input and/or output GPIO 816. In one example, the high-speed bus 812 may be operated as an Advanced High-performance Bus (AHB). As disclosed herein, GPIO signals may be virtualized and transferred over certain serial interfaces, including the SPMI 818, 820, and I2C or I3C interface, and/or an RFFE interface. The transfer of the GPIO signals is facilitated using command codes.

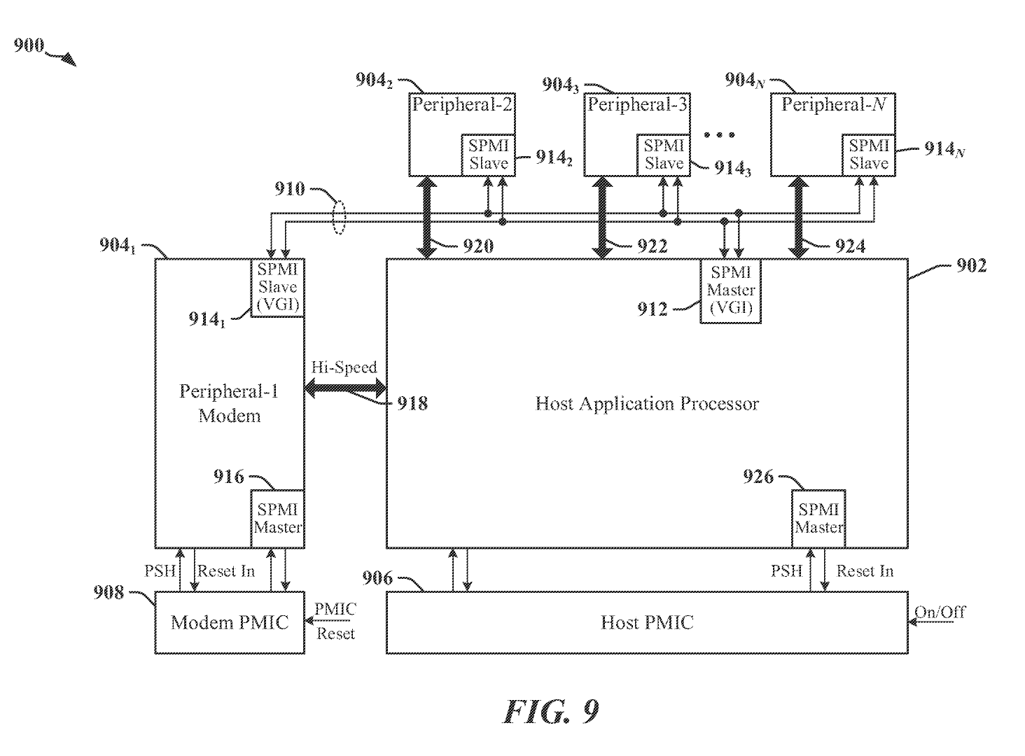

According to certain aspects disclosed herein, GPIO may be consolidated for multiple communication links and devices. FIG. 9 illustrates an example of a system 900 which virtualizes and consolidates communication of GPIO state associated with multiple devices and/or communication links using a single serial communication link. In the illustrated example, a multi-drop serial bus 910 operated in accordance with SPMI protocols may be used to carry virtualized GPIO state information for multiple devices, including for example a host application processor 902 and multiple peripherals 904₁-904_{N}. State information for sideband GPIO associated with each high-speed serial link 918, 920, 922, 924 and other GPIO coupling the host application processor 902 to one or more of the peripherals 904₁-904_{N} may be transmitted as VGI over the serial bus 910. In one example, the host application processor 902 may include an SPMI master 912 and each of the peripherals 904₁-904_{N} may include SPMI slaves 904₁-904_{N} that may be used exclusively for exchange of VGI. In another example, the serial bus 910 may be used for transferring data and commands unrelated to VGI, in addition to VGI. In some examples, one or more of the high-speed serial links 918, 920, 922, 924 be operated as an AHB.

The system 900 may include an application processor 902 that can serve as a host device on various communication links, including the serial bus 910. One or more power management integrated circuits (PMICs 906, 908) may be included in the system 900. In the illustrated system 900, at least a first peripheral 904₁ may include a modem.

Virtualizing GPIO can result in a reduced number of input/output pins, reduce IC package size, and reduces printed circuit board routing complexity. The serial bus 910 may be operated in accordance with SPMI protocols. In some examples, other protocols may be used for transferring VGI at high speed, and with low latency. In one example the RFFE bus may be employed for communicating VGI. As disclosed herein, GPIO signals may be virtualized and transferred over the serial bus 910. The transfer of the GPIO signals may be accomplished without modifying the protocols used on the serial bus 910. In some examples, GPIO consolidation may be implemented using a state machine to control virtualization of GPIO. In many examples, no modification of communication protocol is required. For example, additions, modifications and/or deletions of protocol-defined command and/or common command codes are not required to control virtual GPIO state transmission.

According to certain aspects, multiple GPIO ports can be virtualized such that the GPIO state information transmitted over the serial bus 910 may relate to consolidated state for multiple GPIO ports. In one example, multiple GPIOs may be supported for each port. The state machine may be configured to automatically identify when GPIO state information should be transmitted, and to which devices 902, 904₁-904_{N}, 914_{N} virtualized GPIO state information should be addressed. In some examples, virtual GPIO state information related to one output GPIO may be transmitted and/or routed by the host application processor 902 (for example) to modify input GPIO of two or more of the peripherals 904₁-904_{N}.

In a complex smartphone or tablet system, the host application processor 902 may be coupled to multiple devices 904₁-904_{N}, 914_{N}, and may use a serial bus 910 to signal virtual GPIO information, and thereby obtain a significant reduction in the number of physical I/O pins. The serial bus 910 may be used for the additional purpose of virtualizing a conventional serial bus (UART, I2C, etc.).

Conventional techniques for defining a virtual GPIO environment involve a non-coherent register set definition that includes significant individualized descriptors and device and message parameter association. Virtual GPIO configuration may vary considerably between implementations. The configuration of physical GPIO pins and signals typically varies between applications and the selection of bus used to communicate virtual GPIO information can restrict register and/or data transmission formats. In one example, certain communication protocols may not provide device and register addressing to adequately support virtual GPIO in multi-drop environments. In another example, certain communication protocols may not provide a mechanism to report errors detected during transmission of virtual GPIO information. In another example, certain communication protocols may lack the queuing capability that permits identification of quantities of data to be transmitted. The use of virtual GPIOs can necessitate various register level definitions required to facilitate communication of a complex set of virtual GPIO. These conventional techniques are not atomic in nature, in terms of the configuration, and are not easily scaled. Consequently, conventional implementations result in increased state machine and software architecture complexity.

Certain aspects disclosed herein provide optimized register definitions that may be used to accommodate complex virtual GPIO implementations. Certain aspects ensure atomicity while binding the devices involved along with the parameters required for event-related datagrams transmitted between one or more devices in a multi-drop serial bus. A multi-drop serial bus may be operated, for example, in accordance with SPMI or RFFE, protocols. Certain aspects provide optimized techniques for handling high-speed serial links 918, 920, 922, 924 including for example an AHB, such that 32-bit AHB bus-mapped register bits may be transposed, transformed or otherwise manipulated to enable representation in registers of another bus standard that provides registers addressable in 8-bit or 16-bit widths.

### VGIO Register Definition

According to certain aspects, certain register bit configurations are defined that enable a VGI state machine to operate autonomously, with the ability to interface with registers of different widths. In some examples, the state machine may be adapted to map 32-bit wide AHB registers to 8-bit registers and/or 16-bit register. Other mappings may be implemented according to preference or requirement of certain architectures.

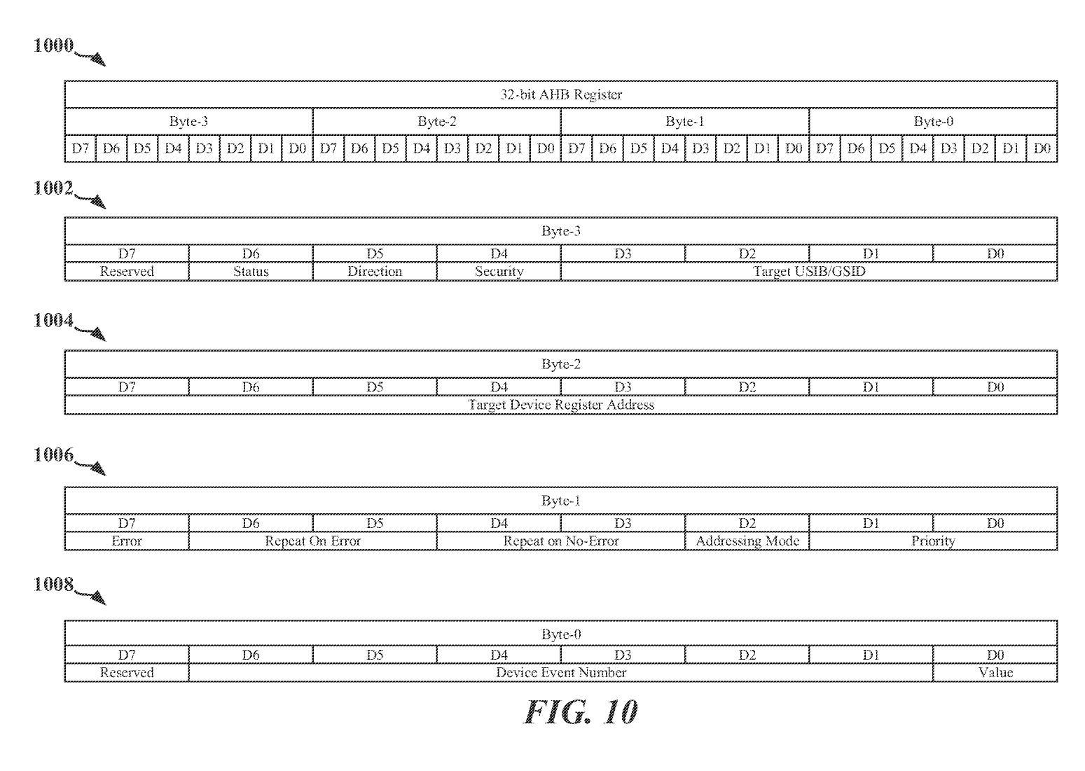

FIG. 10 illustrates one example of a configuration of an event register 1000 that may be used to implement a versatile virtual GPIO configuration. The event register 1000 is 32 bits wide, and may be implemented as an AHB bus-mapped register. The event register 1000 defines parameters used to communicate virtual GPIO information between devices. In some examples, the event register 1000 may be communicated in bytes 1002, 1004, 1006, 1008, each 8 bits wide.

Bit definitions for the first byte 1002 may include:
D7: Reserved for future or application-specific use.
D6: Virtual GPIO status. For example, when D6=1, event servicing is pending and when D6=0, no event servicing is required or needed.
D5: Defines direction of event information, where D5=1 when an event is for transmission (output) and D5-0 when the event is for reception (input).
D4: Defines security for event communication. For example, D4=1 when event information is to be transmitted or received using encryption/decryption. Unsecured transmission is indicated when D4=0. Many master-based execution environments (EE) may have access to the bus, but the security entity controls which EEs have access to each remote device, and/or to specific registers within the remote device.
D3-D0: Encodes a target device address. In this example, 16 devices may be addressed using a 4-bit unique slave identifier (USID) or group slave identifier (GSID)

In the event register 1000 illustrated in FIG. 10, the second byte 1004 may include an 8-bit register address in the target device. The register address may identify a device-specific register to which an event code is to be transmitted and/or read.

Bit definitions for the third byte 1006 may include:
D7: Error bit indicating that an error has been detected when D=1, and that no error has been detected when D=0.
D6-D5: (ROE) defines repeat on error configuration, where a zero value for ROE indicates that no repeat transmission is to be performed after error detection, and a non-zero value indicates the number of repeat transmissions to be attempted. In one example, the value of ROE represents the number of transmission attempts (i.e., 0-3) that can be performed after an error is detected.
D4-D3: (RONE) defines repeat on no error configuration, where a zero value for RONE indicates that no repeat transmission is to be performed, and a non-zero value indicates the number of repeat transmissions to be performed. In one example, the value of RONE represents the number of transmission attempts (i.e., 0-3) to be performed.
D2: (AM) defines addressing mode to be used to address registers in a target device. In one example, AM=1 indicates offset addressing mod, where the register address is provided as an offset from a base address, and AM=0 indicates direct addressing mode where the register address (byte 2) is the assigned address of a target register in a target device.
D1-D0: Priority values define or quantify the priority of the event information.

Priority values may be used to queue multiple events for transmission to a single target device.

Bit definitions for the fourth byte 1008 may include:
D7: Reserved for future or application-specific use.
D6-D1: Event number. In one example, a 6-bit event number can indicate events in the range 0b000000 to 011111111 for a total of 64 events.
D0: Event value (0 or 1).

The configuration of the event register 1000 illustrated in FIG. 10 enables a finite state machine (FSM) to operate independently of the capabilities of the communication link used to carry virtual GPIO and of the internal configuration and of devices that the physical GPIO.

Other configurations of the event register 1000 may be used in some implementations. Different register configurations may include similar information is different formats. The information may include:
I/P and O/P event status: Event pending to be transmitted or Event received and pending to be served.
Direction of transmission of event (input or output).
Secured or non-secured transmission option.
Address of target device (USID of GSID).
Register address in target device, should a non-offset addressing mode be used for sending the event-code.
Error status (error bit).
Per-event transmission repeat option on occurrence of error.
Per-event transmission repeat option for added robustness when no error occurs.
Addressing mode to select between offset-addressing with respect to a base address, or direct register addressing for addressing flexibility.
Device event number (e.g., a number accommodating up to 64 events).
Event binary value (one or more bits).

Some bit locations may be reserved for future expansion, and/or for application-specific information.

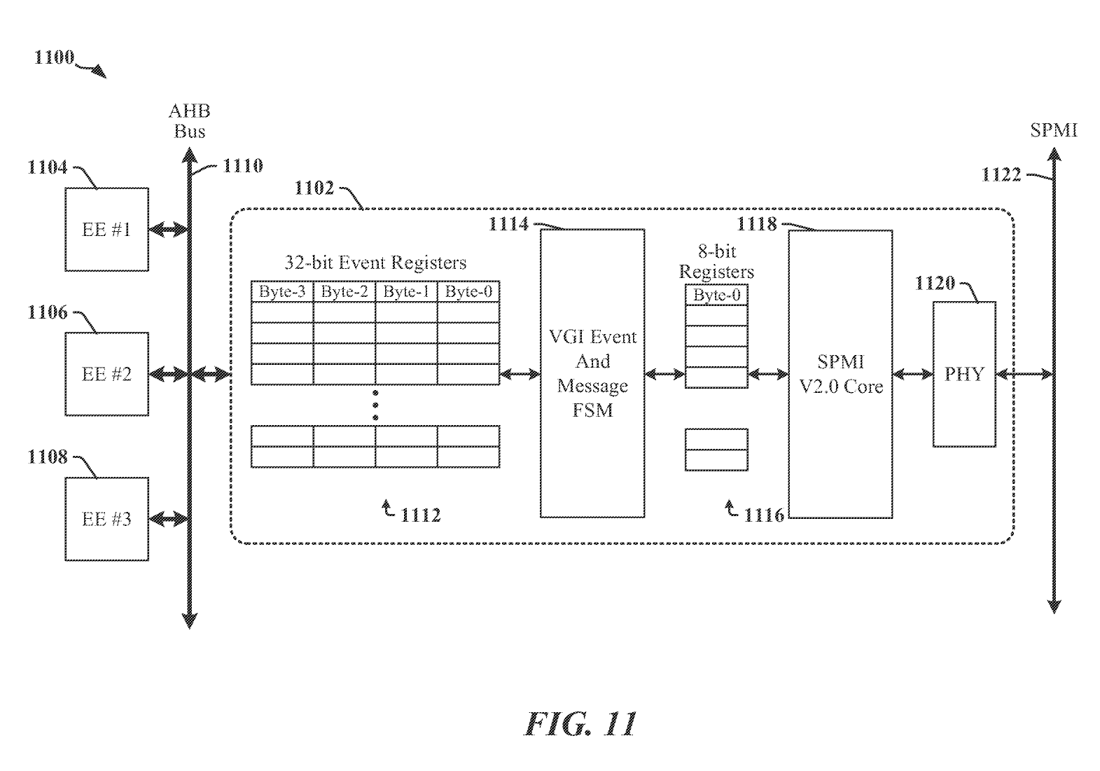

FIG. 11 illustrates an example of system 1100 that employs an FSM-based virtual GPIO management system 1102 that enables an FSM 1114 to operate autonomously using an event register such as the event register 1000 of FIG. 10. The system 1100 may include one or more execution environments 1104, 1106, 1108, where an execution environment may provide a processing circuit and/or a processor with associated memory and peripheral devices provided within an IC. In one example, two or more execution environments 1104, 1106, 1108 may be included in an SoC. In the example, the execution environments 1104, 1106, 1108 and the FSM-based virtual GPIO management system 1102 are coupled to a 32-bit AHB bus 1110. VGIO event information is recorded in 32-bit event registers 1112, which may be formatted as illustrated in FIG. 10. The FSM operates on the 32-bit event registers 1112 and communicates virtual GPIO information through device registers 1116. In the illustrated example, the device registers 1116 are 8-bit registers that comply or are compatible with SPMI protocols. An SPMI processing core 1118 communicates through physical layer circuits (PHY 1120) over a serial bus 1122, which is operated in accordance with SPMI protocols. The FSM 1114 may write a sequence of values to the device registers 1116 that can be relayed by the SPMI processing core 1118 to devices coupled to serial bus 1122.

In one example, the 32-bit event registers 1112 may be configured for a transmit-event operation as follows:

| | |
|---|---|
| Set DIR {Byte-3.D5} = 1 | // Direction as O/P |
| Set SECU {Byte-3.D4} 1 or 0 | // SECU=1 (if secured operation desired), Else |
| | SECU = 0 (non-secure operation) |
| Set USID/GSID {Byte-3.[D3..D0]} = 1 | // USID or GSID value of target device(s) |
| Set Byte-2 : Target_Device_Register_Address | //Value = Register address for event-code when |
| | Register-mode Tx used |
| Set ROE {Byte-1.[D6..D5]} | // set transmit repeat count on Error |
| Set RONE {Byte-1.[D4..D3]} | // set transmit repeat count on no-error |
| Set AM {Byte-1.[D2]} | // set addressing mode |
| Set PRIORITY {Byte-1.[D1..D0]} | // set event priority. 11 => highest priority, 00 => |
| | lowest priority |
| Set DEVICE_EVENT_NUM {Byte-0.[D6..D1]} | // set Event_Number |
| Set VAL {Byte-0.[D0]} | // 1 or 0 per the desired Event_Value |

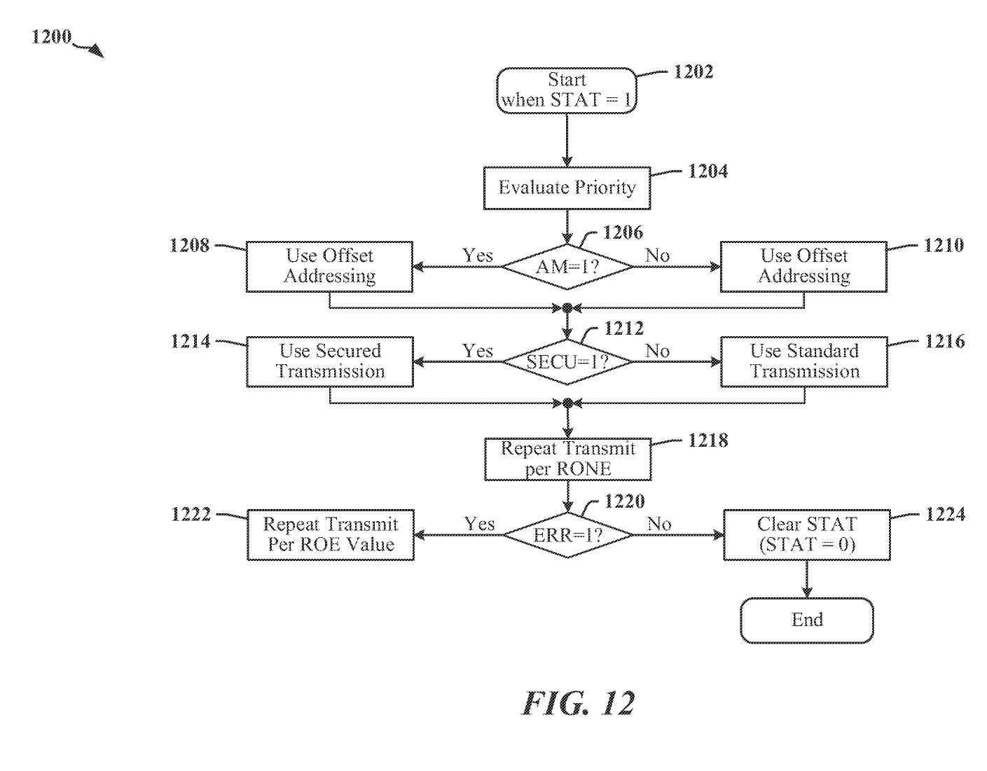

FIG. 12 is a flowchart 1200 illustrating processing of a 32-bit event register 1112 during an event transmission operation. The event transmission operation may commence at block 1202 when the status bit (STAT) is set, indicating that event servicing is pending. At block 1204, the priority of the pending event may be evaluated to determine when transmission can commence. For example, information related to higher priority events may be transmitted first and lower priority events may remain unprocessed until completion of transmissions related to the higher priority events.

At block 1206, the addressing mode associated with the event is determined. In one mode, direct register addressing is configured at block 1208. In a second mode, offset addressing is configured at block 1210. At block 1212, the security setting associated with the event is configured. For one setting, event-related information is transmitted by secured transmission at block 1214. Secured transmission may include encryption of the event information. For another setting, event-related information is transmitted in a standard, normal, unencrypted and/or otherwise unsecured transmission at block 1216.

At block 1218, the RONE setting is examined to determine if retransmission is indicated. Retransmission of the event-related information may be performed to enhance integrity of the virtual GPIO implementation. At block 1220, the ERR bit is checked to determine if a communication error occurred. The ERR bit may be set in response to receipt of a NACK, for example. In another example, the ERR bit may be set when an ACK is not received. If an error is indicated, retransmission may occur at block 1222 in accordance with the RONE parameter. If no error is indicated, the STAT bit may be cleared at block 1224, and the process may be terminated.

In some examples, the 32-bit event registers 1112 may be configured for a receive-event operation as follows:

| | |
|---|---|
| Set DIR {Byte-3.D5} = 0 | // Direction as I/P |
| Set SECU {Byte-3.D4} 1 or 0 | // SECU=1 (if secured operation desired ), Else |
| | SECU = 0 (non-secure operation) |
| Set USID/GSID {Byte-3.[D3..D0]} = 1 | // USID or GSID value of target device(s) |
| Set Byte-2 : Target_Device_Register_Address | //Value = Register address for event-code when |
| | Register-mode Rx used |
| Set ROE {Byte-1.[D6..D5]} | // set transmit repeat count on Error |
| Set RONE {Byte-1.[D4..D3]} | // set transmit repeat count on no-error |
| Set AM {Byte-1.[D2]} | // set addressing mode |
| Set PRIORITY {Byte-1.[D1..D0]} | // set event priority. 11 => highest priority, 00 => |
| | lowest priority |
| Set DEVICE_EVENT_NUM {Byte-0.[D6..D1]} | // set Event_Number |

In this example, the USID/GSID {Byte-3.[D3. . . . D0]}, ROE {Byte-1.[D6 . . . D5]}, PRIORITY {Byte-1.[D1 . . . D0]} and VAL {Byte-0.[D0]} are ignored.

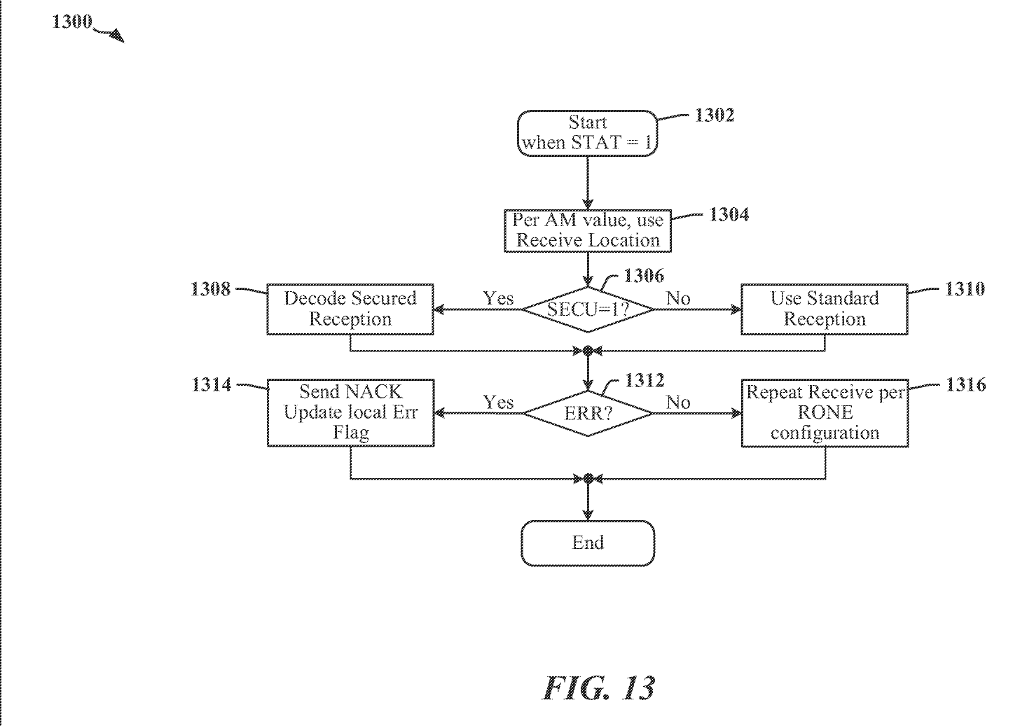

FIG. 13 is a flowchart 1300 illustrating processing of a 32-bit event register 1112 during an event receive operation. The event receive operation may commence at block 1302 when the status bit (STAT) is set, indicating that event servicing is pending. At block 1304, information associated with the pending event may be received in accordance with the configured addressing mode.

At block 1306, the security setting associated with the event is determined. For one setting, event-related information is decoded at block 1308 when a secured transmission was used to transmit the event-related information. The event information may be decrypted at block 1308. For another setting, event-related information was transmitted in a standard, normal, unencrypted and/or otherwise unsecured transmission, and the event information may be received normally at block 1310.

At block 1312, it may be determined whether a communication error occurred. Communication errors may be detected through the use of parity checking, cyclic redundancy checking, differences between information received after multiple duplicate transmissions, and so on. If an error occurred, a NACK may be transmitted at block 1314. If no error occurred, additional transmissions of the evet information may be received at block 1316 in accordance with the RONE parameter.

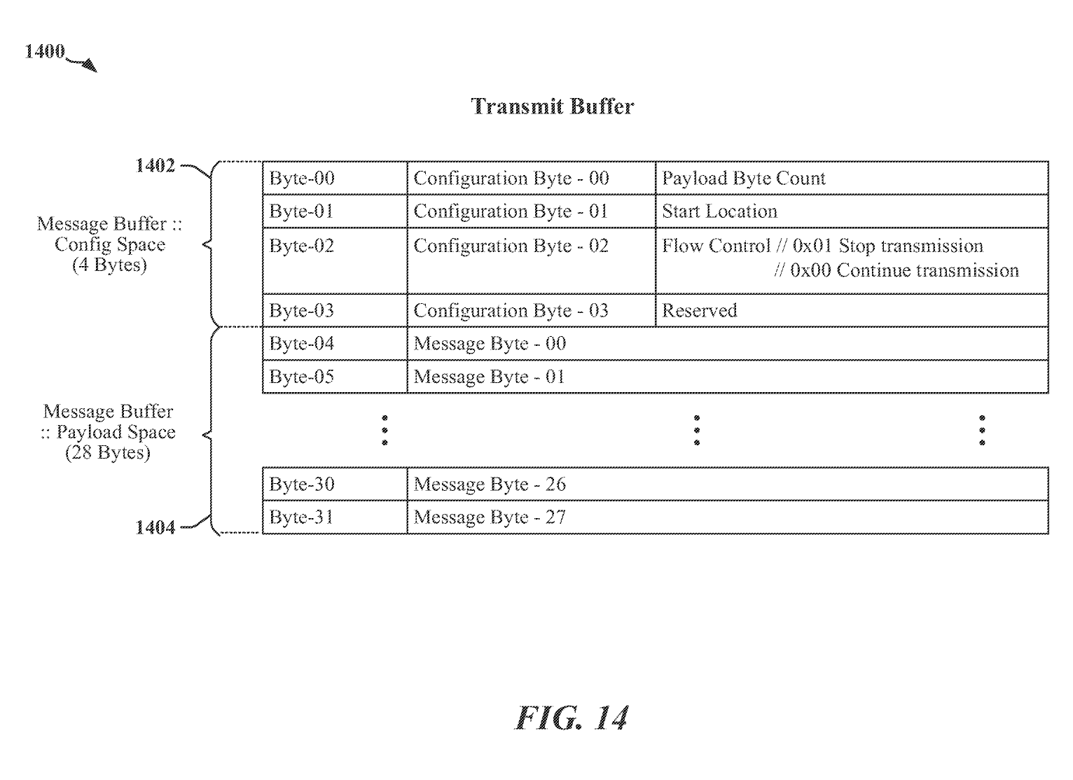

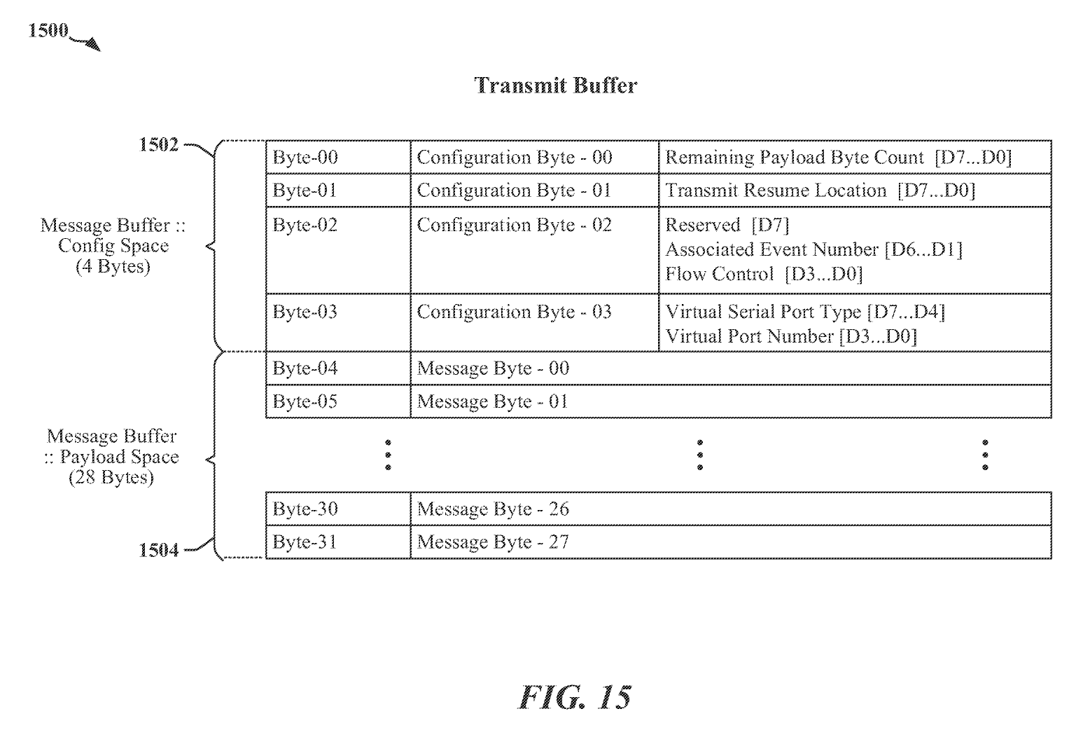

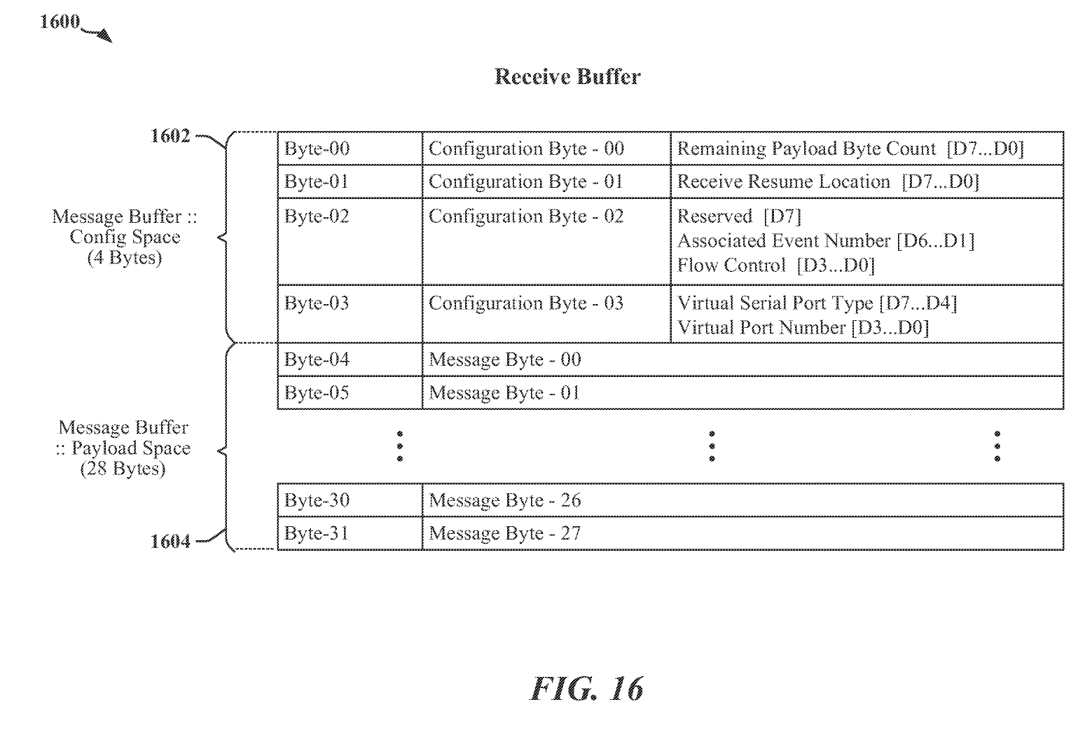

FIGS. 14-16 provide examples of message buffers 1400, 1500, 1600 that include a configuration space 1402, 1502, 1602 and a payload space 1404, 1504, 1604. In the illustrated example, each configuration space 1402, 1502, 1602 includes byte-sized fields that identify the number of valid bytes in the corresponding payload space 1404, 1504, 1604 and a start or resume location for reading or writing data. In some examples, the configuration space 1402, 1502, 1602 carries event number and/or information that signals flow-control requests. In some examples, the configuration space 1402, 1502, 1602 includes a field that specifies a virtual serial port type and/or a virtual port number.

A message flow for a master-originated message may proceed as follows:
Master first sends the Payload-byte count information to the associated Receive buffer.
Master then proceeds sending the payload bytes.
At the end of each datagram, the master reads the flow control bit to see if the receiver intends to assert flow control.
Master holds the transmit operation and releases the bus if flow control is detected.
Master won't resume transmit operation until again the receiver sends event trigger to resume transmit operation.

A message flow for a slave-originated message may proceed as follows:
Slave sends transmit trigger to master or associated slave after winning arbitration.
Slave must re-win arbitration to send all payload bytes.
Flow control is handled in accordance with flow control logic defined for a bus master.

### Examples of Processing Circuits and Methods

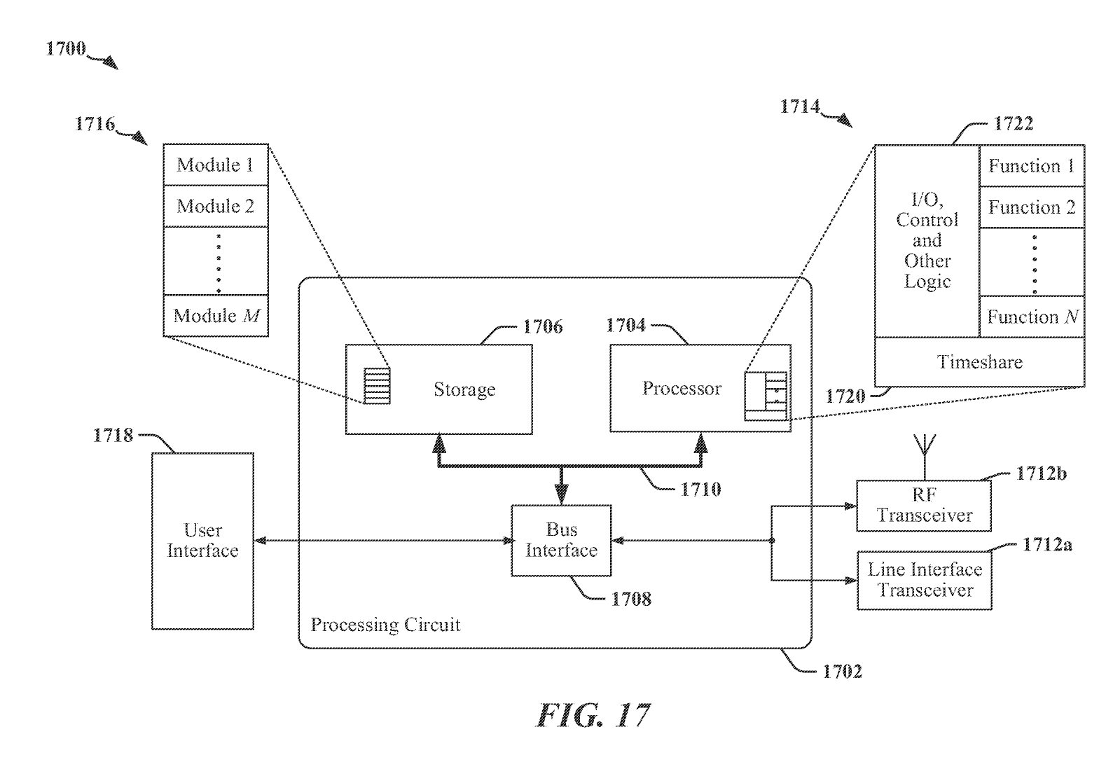

FIG. 17 is a diagram illustrating an example of a hardware implementation for an apparatus 1700 employing a processing circuit 1702. The processing circuit 1702 may include or configure the operation of a finite state machine 710 (see FIG. 7). In some examples, the apparatus 1700 may perform one or more functions disclosed herein. In accordance with various aspects of the disclosure, an element, or any portion of an element, or any combination of elements as disclosed herein may be implemented using a processing circuit 1702. The processing circuit 1702 may include one or more processors 1704 that are controlled by some combination of hardware and software modules. Examples of processors 1704 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1704 may include specialized processors that perform specific functions, and that may be configured, augmented or controlled by one of the software modules 1716. The one or more processors 1704 may be configured through a combination of software modules 1716 loaded during initialization, and further configured by loading or unloading one or more software modules 1716 during operation.

In the illustrated example, the processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including the one or more processors 1704, and storage 1706. Storage 1706 may include memory devices and mass storage devices, and may be referred to herein as computer-readable media and/or processor-readable media.

In some examples, the storage 1706 includes registers used to communicate virtual GPIO information. One set of registers may be configured to maintain address, management and payload information corresponding to a physical GPIO and one or more devices to which virtual GPIO information is transmitted. Another set of registers may maintain information in a format corresponding to the one or more devices to which the virtual GPIO information is transmitted.

The bus 1710 may also link various other circuits such as timing sources, timers, peripherals, voltage regulators, and power management circuits. A bus interface 1708 may provide an interface between the bus 1710 and one or more transceivers 1712a, 1712b. A transceiver 1712a, 1712b may be provided for each networking technology supported by the processing circuit. In some instances, multiple networking technologies may share some or all of the circuitry or processing modules found in a transceiver 1712a, 1712b. Each transceiver 1712a, 1712b provides a means for communicating with various other apparatus over a transmission medium. In one example, a transceiver 1712a may be used to couple the apparatus 1700 to a multi-wire bus. In another example, a transceiver 1712b may be used to connect the apparatus 1700 to a radio access network. Depending upon the nature of the apparatus 1700, a user interface 1718 (e.g., keypad, display, speaker, microphone, joystick) may also be provided, and may be communicatively coupled to the bus 1710 directly or through the bus interface 1708.

A processor 1704 may be responsible for managing the bus 1710 and for general processing that may include the execution of software stored in a computer-readable medium that may include the storage 1706. In this respect, the processing circuit 1702, including the processor 1704, may be used to implement any of the methods, functions and techniques disclosed herein. The storage 1706 may be used for storing data that is manipulated by the processor 1704 when executing software, and the software may be configured to implement any one of the methods disclosed herein.

One or more processors 1704 in the processing circuit 1702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1706 or in an external computer-readable medium. The external computer-readable medium and/or storage 1706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1706 may also include, by way of example, a carrier wave, a transmission line, and any other suitable medium for transmitting software and/or instructions that may be accessed and read by a computer. Computer-readable medium and/or the storage 1706 may reside in the processing circuit 1702, in the processor 1704, external to the processing circuit 1702, or be distributed across multiple entities including the processing circuit 1702. The computer-readable medium and/or storage 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1706 may maintain software maintained and/or organized in loadable code segments, modules, applications, programs, etc., which may be referred to herein as software modules 1716. Each of the software modules 1716 may include instructions and data that, when installed or loaded on the processing circuit 1702 and executed by the one or more processors 1704, contribute to a run-time image 1714 that controls the operation of the one or more processors 1704. When executed, certain instructions may cause the processing circuit 1702 to perform functions in accordance with certain methods, algorithms and processes described herein.

Some of the software modules 1716 may be loaded during initialization of the processing circuit 1702, and these software modules 1716 may configure the processing circuit 1702 to enable performance of the various functions disclosed herein. For example, some software modules 1716 may configure internal devices and/or logic circuits 1722 of the processor 1704, and may manage access to external devices such as the transceivers 1712a, 1712b, the bus interface 1708, the user interface 1718, timers, mathematical coprocessors, and so on. The software modules 1716 may include a control program and/or an operating system that interacts with interrupt handlers and device drivers, and that controls access to various resources provided by the processing circuit 1702. The resources may include memory, processing time, access to the transceivers 1712a, 1712b, the user interface 1718, and so on.

One or more processors 1704 of the processing circuit 1702 may be multifunctional, whereby some of the software modules 1716 are loaded and configured to perform different functions or different instances of the same function. The one or more processors 1704 may additionally be adapted to manage background tasks initiated in response to inputs from the user interface 1718, the transceivers 1712a, 1712b, and device drivers, for example. To support the performance of multiple functions, the one or more processors 1704 may be configured to provide a multitasking environment, whereby each of a plurality of functions is implemented as a set of tasks serviced by the one or more processors 1704 as needed or desired. In one example, the multitasking environment may be implemented using a timesharing program 1720 that passes control of a processor 1704 between different tasks, whereby each task returns control of the one or more processors 1704 to the timesharing program 1720 upon completion of any outstanding operations and/or in response to an input such as an interrupt. When a task has control of the one or more processors 1704, the processing circuit is effectively specialized for the purposes addressed by the function associated with the controlling task. The timesharing program 1720 may include an operating system, a main loop that transfers control on a round-robin basis, a function that allocates control of the one or more processors 1704 in accordance with a prioritization of the functions, and/or an interrupt driven main loop that responds to external events by providing control of the one or more processors 1704 to a handling function.

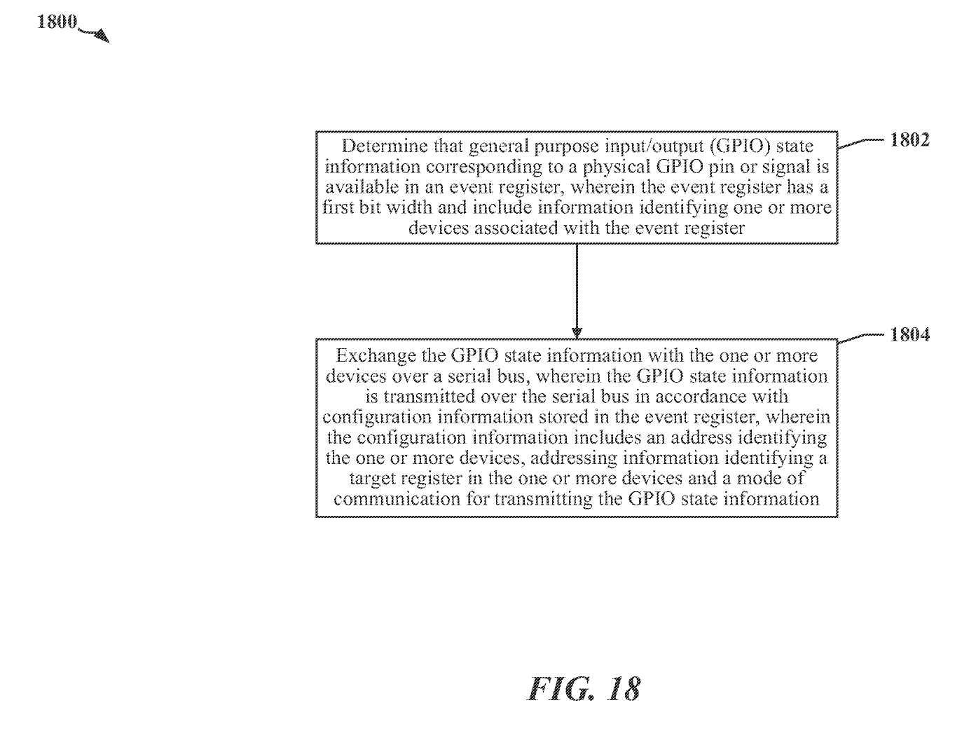

FIG. 18 is a flowchart 1800 of a method that may be performed at a device coupled to a serial bus. Portions of the method may be performed by a finite state machine in the transmitting device.

At block 1802, the finite state machine may determine that GPIO state information corresponding to a physical GPIO pin or signal is available in an event register. The event register may have a first bit width. The event register may include information identifying one or more devices associated with the event register.

At block 1804, the finite state machine may exchange the GPIO state information with the one or more devices over a serial bus. The GPIO state information may be transmitted over the serial bus in accordance with configuration information stored in the event register. The configuration information may include an address identifying the one or more devices. The configuration information may include addressing information identifying a target register in the one or more devices. The configuration information may include information identifying a mode of communication for transmitting the GPIO state information.

In certain examples, the finite state machine may store the GPIO state information in a first device register, and transmit the first device register over the serial bus. The finite state machine may store an address identifying the one or more devices in a second device register, and transmit the second device register with the first device register over the serial bus. The finite state machine may store an address identifying the target register in a third device register, and transmit the third device register with the first device register over the serial bus. The first device register may have a second bit width that is different from the first bit width.

In one example, the mode of communication defines whether the GPIO state information is encrypted when transmitted. In another example, the mode of communication defines whether messages are encrypted when transmitted over the serial bus. In another example, the mode of communication defines whether the GPIO state information is retransmitted after an error is detected in a first transmission. In another example, the mode of communication defines whether the GPIO state information is transmitted in multiple transmission. In another example, the mode of communication defines a format of the addressing information identifying the target register in the one or more devices. In another example, the mode of communication identifies a priority of the GPIO state information.

In one example, the finite state machine may exchange the GPIO state information by transmitting or receiving a data packet in accordance with a SPMI protocol. In another example, the finite state machine may exchange the GPIO state information by transmitting or receiving a data packet in accordance with an RFFE protocol.

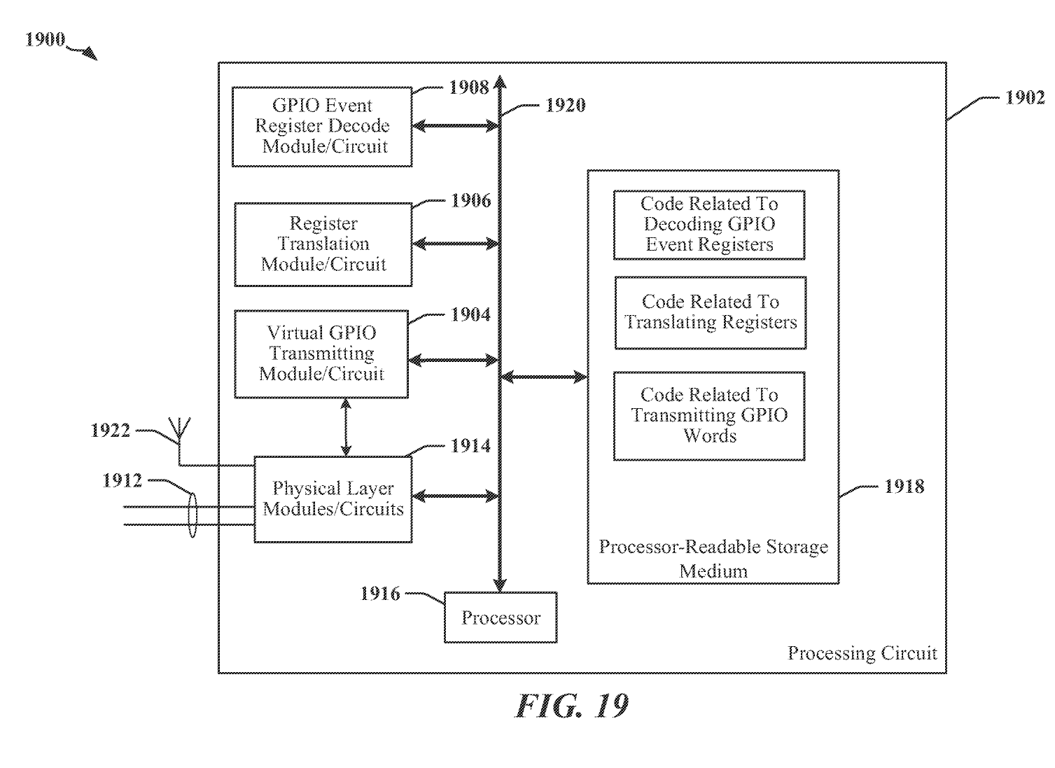

FIG. 19 is a diagram illustrating a simplified example of a hardware implementation for an apparatus 1900 employing a processing circuit 1902. The apparatus may implement a bridging circuit in accordance with certain aspects disclosed herein. The processing circuit typically has a controller or processor 1916 that may include one or more microprocessors, microcontrollers, digital signal processors, sequencers and/or state machines. The processing circuit 1902 may be implemented with a bus architecture, represented generally by the bus 1920. The bus 1920 may include any number of interconnecting buses and bridges depending on the specific application of the processing circuit 1902 and the overall design constraints. The bus 1920 links together various circuits including one or more processors and/or hardware modules, represented by the controller or processor 1916, the modules or circuits 1904, 1906 and 1908, and the processor-readable storage medium 1918. One or more physical layer circuits and/or modules 1914 may be provided to support communications over a communication link implemented using a multi-wire bus 1912, through an antenna 1922 (to a radio access network for example), and so on. The bus 1920 may also link various other circuits such as timing sources, peripherals, voltage regulators, and power management circuits, which are well known in the art, and therefore, will not be described any further.

The processor 1916 is responsible for general processing, including the execution of software, code and/or instructions stored on the processor-readable storage medium 1918. The processor-readable storage medium may include a non-transitory storage medium. The software, when executed by the processor 1916, causes the processing circuit 1902 to perform the various functions described supra for any particular apparatus. The processor-readable storage medium may be used for storing data that is manipulated by the processor 1916 when executing software. The processing circuit 1902 further includes at least one of the modules 1904, 1906 and 1908. The modules 1904, 1906 and 1908 may be software modules running in the processor 1916, resident/stored in the processor-readable storage medium 1918, one or more hardware modules coupled to the processor 1916, or some combination thereof. The modules 1904, 1906 and 1908 may include microcontroller instructions, state machine configuration parameters, or some combination thereof.

In one configuration, the apparatus 1900 includes modules and/or circuits 1908 configured to decode information maintained in a GPIO event register, modules and/or circuits 1906 configured to translate the information maintained in the GPIO event register to populate one or more device registers, and modules and/or circuits 1904 configured to transmit a packet comprising the GPIO word.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a device coupled to a serial bus, comprising:
determining that general purpose input/output (GPIO) state information corresponding to a physical GPIO pin or signal is available in an event register, wherein the event register has a first bit width and includes information identifying one or more devices associated with the event register; and
exchanging the GPIO state information with the one or more devices over the serial bus, wherein the GPIO state information is transmitted over the serial bus in accordance with configuration information stored in the event register,
wherein the configuration information includes an address identifying the one or more devices, addressing information identifying a target register in the one or more devices and information identifying a mode of communication for transmitting the GPIO state information.

2. The method of claim 1, further comprising:
storing the GPIO state information in a first device register; and
transmitting content of the first device register over the serial bus.

3. The method of claim 2, further comprising:
storing the address identifying the one or more devices in a second device register; and
transmitting content of the second device register with the content of the first device register over the serial bus.

4. The method of claim 2, further comprising:
storing an address identifying the target register in a third device register; and
transmitting content of the third device register with the content of the first device register over the serial bus.

5. The method of claim 2, wherein the first device register has a second bit width that is different from the first bit width.

6. The method of claim 1, wherein the mode of communication defines whether the GPIO state information is encrypted when transmitted.

7. The method of claim 1, wherein the mode of communication defines whether messages are encrypted when transmitted over the serial bus.

8. The method of claim 1, wherein the mode of communication defines whether the GPIO state information is retransmitted after an error is detected in a first transmission.

9. The method of claim 1, wherein the mode of communication defines whether the GPIO state information is transmitted in multiple transmission.

10. The method of claim 1, wherein the mode of communication defines a format of the addressing information identifying the target register in the one or more devices.

11. The method of claim 1, wherein the mode of communication identifies a priority of the GPIO state information.

12. The method of claim 1, wherein exchanging the GPIO state information comprises:
transmitting or receiving a data packet in accordance with a system power management interface (SPMI) protocol.

13. The method of claim 1, wherein exchanging the GPIO state information comprises:
transmitting or receiving a data packet in accordance with a radio frequency front-end (RFFE) protocol.

14. An apparatus, comprising:
a set of event registers, each event register storing general purpose input/output (GPIO) state information corresponding to a physical GPIO pin or signal and configuration information corresponding to the GPIO state information;
a bus interface configured to communicate virtual GPIO information over a serial bus; and
a finite state machine coupled to the set of event registers and the bus interface, and configured to:
determine that the GPIO state information corresponding to a physical GPIO pin or signal has changed in a first event register, wherein the first event register has a first bit width and includes information identifying one or more devices associated with the first event register; and
exchange the GPIO state information with the one or more devices over the serial bus, wherein the GPIO state information is transmitted over the serial bus in accordance with the configuration information stored in the first event register,
wherein the configuration information includes an address identifying the one or more devices, addressing information identifying a target register in the one or more devices and information identifying a mode of communication for transmitting the GPIO state information.

15. The apparatus of claim 14, further comprising:
a first device register corresponding to the target register,
wherein the finite state machine is configured to:
store the GPIO state information in the first device register; and
transmit content of the first device register over the serial bus.

16. The apparatus of claim 15, wherein the finite state machine is further configured to:
store the address identifying the one or more devices in a second device register; and
transmit content of the second device register with the content of the first device register over the serial bus.

17. The apparatus of claim 15, wherein the finite state machine is further configured to:
store an address identifying the target register in a third device register; and
transmit content of the third device register with the content of the first device register over the serial bus.

18. The apparatus of claim 15, wherein the first device register has a second bit width that is different from the first bit width.

19. The apparatus of claim 14, wherein the finite state machine is further configured to exchange the GPIO state information by:
transmitting or receiving a data packet in accordance with a system power management interface (SPMI) protocol.

20. The apparatus of claim 14, wherein the finite state machine is further configured to exchange the GPIO state information by:
transmitting or receiving a data packet in accordance with a radio frequency front-end (RFFE) protocol.

21. An apparatus comprising:
means for determining that general purpose input/output (GPIO) state information corresponding to a physical GPIO pin or signal is available in an event register, wherein the event register has a first bit width and includes information identifying one or more devices associated with the event register; and
means for exchanging the GPIO state information with the one or more devices over a serial bus, wherein the GPIO state information is transmitted over the serial bus in accordance with configuration information stored in the event register,
wherein the configuration information includes an address identifying the one or more devices, addressing information identifying a target register in the one or more devices and information identifying a mode of communication for transmitting the GPIO state information.

22. The apparatus of claim 21, wherein the GPIO state information is stored in a first device register, and the means for exchanging the GPIO state information transmits content of the first device register over the serial bus.

23. The apparatus of claim 22, wherein the address identifying the one or more devices is stored in a second device register, and the means for exchanging the GPIO state information transmits content of the second device register with the content of the first device register over the serial bus.

24. The apparatus of claim 22, wherein an address identifying the target register is stored in a third device register, and the means for exchanging the GPIO state information transmits content of the third device register with the content of the first device register over the serial bus.

25. The apparatus of claim 22, wherein the first device register has a second bit width that is different from the first bit width.

26. A processor-readable storage medium having instructions stored thereon which, when executed by at least one processor or state machine of a processing circuit, cause the processing circuit to:
determine that general purpose input/output (GPIO) state information corresponding to a physical GPIO pin or signal is available in an event register, wherein the event register has a first bit width and includes information identifying one or more devices associated with the event register; and
exchange the GPIO state information with the one or more devices over a serial bus, wherein the GPIO state information is transmitted over the serial bus in accordance with configuration information stored in the event register,
wherein the configuration information includes an address identifying the one or more devices, addressing information identifying a target register in the one or more devices and information identifying a mode of communication for transmitting the GPIO state information.

27. The storage medium of claim 26, wherein the instructions further cause the processing circuit to:
store the GPIO state information in a first device register; and
transmit content of the first device register over the serial bus.

28. The storage medium of claim 27, wherein the instructions further cause the processing circuit to:
store the address identifying the one or more devices in a second device register; and
transmit content of the second device register with the content of the first device register over the serial bus.

29. The storage medium of claim 27, wherein the instructions further cause the processing circuit to:
store an address identifying the target register in a third device register; and
transmit content of the third device register with the content of the first device register over the serial bus.

30. The storage medium of claim 27, wherein the first device register has a second bit width that is different from the first bit width.
